(19) United States
(12) Patent Application Publication
(10) Pub. No.: US 2009/0024958 A1
(43) Pub. Date: Jan. 22, 2009

(54) Program product including display control program and computer-readable media, display device, display control method, and image forming apparatus

(75) Inventor: Junko Itou, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/890,825

(22) Filed: Aug. 8, 2007

(30) Foreign Application Priority Data
Aug. 9, 2006 (JP) 2006-216825
Aug. 11, 2006 (JP) 2006-220399
Sep. 27, 2006 (JP) 2006-262781

(51) Int. Cl. G06F 3/048

(52) U.S. Cl. 715/805

(57) ABSTRACT

A program product, including: a display control program for allowing a display portion to display an operation guide for an operator; and a computer-readable media storing the display control program. The display control program allows a computer to serve as: a display controller which allows the display portion to display an operation guide screen presenting to an operator that values of a plurality of items are changeable; and a set change reception portion which receives from the operator instructions of changing the set values of the items when the display controller allows the display portion to display the operation guide screen. The display controller allows a display form of a display part for a predetermined description to be different from other display area in the operation guide screen when the display controller allows the display portion to display the operation guide screen.

### BACKGROUND OF THE INVENTION

1. Field of the Invention

The present invention relates to a program product including a display control program and a computer-readable media, a display device, a display control method and an image forming apparatus. More particularly, it relates to a technology of displaying an operation guide for an operator.

2. Description of the Related Art

Conventionally, there has been a technology of allowing a display of a computer, image forming apparatus, and the like to display an operation guide for an operator. As an example of adopting this technology, there has been a file data print output method disclosed in Japanese Patent Unexamined Publication No. 2003-316536. According to this file data print output method, a second printer icon 202 composed of portions 202A˜202H respectively showing optional functions of an image forming apparatus is pulled down from a first printer icon 201 displayed on a taskbar of a monitor screen when file data is outputted which is under edition with use of an application software at a personal computer. When an operator clicks any one part of the pulled-down display with a pointer, the personal computer outputs to an image forming apparatus file data which is under edition along with an instruction of executing a function corresponding to the designated portion.

Generally, when an operation guide is displayed on a display and an operator would like to set detailed items such as a page layout, magnification ratio, and sheet setting, it is often the case that the operator cannot set the detailed items in a first display window of a printer driver and needs to display an operation window allocated at further lower hierarchical layer to set the detailed items. Further, it is also often the case that the operator cannot confirm settings in the operation window allocated in the lower hierarchical layer without allowing the lower hierarchical layer to be displayed. According to the above-described file data print output method disclosed in the above-mentioned Japanese Patent Unexamined Publication No. 2003-316536, functions of an image forming apparatus can be selected easily and assuredly. However, the operator has to allow the operation window of the lower hierarchical layer to be displayed to confirm settings of the operation window of the lower hierarchical layer. Accordingly, the operator has to perform an operation which is similar to the operation described above. Consequently, inconvenience for an operator at the time of confirming detailed settings cannot be resolved.

### SUMMARY OF THE INVENTION

The present invention has been worked out to solve the above-described problems, and its object is to allow an operator to easy easily confirm settings at the time of operation and improve operability.

Specifically, the present invention includes a program product comprising: a display control program for allowing a display portion to display an operation guide for an operator; and a computer-readable media storing the display control program. The display control program allows a computer to serve as: a display controller which allows the display portion to display an operation guide screen presenting to an operator that values of a plurality of items are changeable; and a set change reception portion which receives from the operator instructions of changing the set values of the items when the display controller allows the display portion to display the operation guide screen. The display controller allows a display form of a display part for a predetermined description to be different from other display area in the operation guide screen when the display controller allows the display portion to display the operation guide screen.

According to the present invention, the display controller allows a display form of a display part for a predetermined description to be different from other display area in the operation guide screen when the display controller allows the display portion to display the operation guide screen. Accordingly, an operator can easily confirm settings regarding the predetermined description at the time of operation, and operability improves.

### BRIEF DESCRIPTION OF THE DRAWINGS

FIG. 1 is a block diagram showing a schematic configuration of a personal computer in which a display control program according to an embodiment of the present invention is installed (hereinafter, a personal computer in which the display control program is installed is referred to as a PC).

FIG. 2 is a flowchart showing a first embodiment of a display control executed by the PC at the time of printing.

FIG. 3 shows an example of a window display of a display portion.

FIG. 4 shows an example of a window display of the display portion.

FIG. 5 shows an example of a window display of the display portion.

FIG. 6 shows an example of a window display of the display portion.

FIG. 7 shows an example of a window display of the display portion.

FIG. 8 shows an example of a window display of the display portion.

FIG. 9 is a flowchart showing a second embodiment of the display control executed by the PC at the time of printing.

FIG. 10 shows an example of a detailed item setting window.

FIG. 11 is a flowchart showing a third embodiment of the display control executed by the PC at the time of printing.

FIG. 12 is a flowchart showing a processing of changing an item set value in a separate window.

FIG. 13 shows an example of a window display of the display portion.

FIG. 14 is a flowchart showing a fourth embodiment of the display control executed by the PC at the time of printing.

FIG. 15 shows an example of a window display of the display portion.

FIG. 16 shows an example of a window display of the display portion.

FIG. 17 shows an example of a window display of the display portion.

FIG. 18 shows an example of a window display of the display portion.

FIG. 19 is a flowchart showing another embodiment of a processing of changing a set value of an item in the detailed item setting window.

FIG. 20 shows an example of a window display of the display portion.

FIG. 21 is a flowchart showing a fifth embodiment of the display control executed by the PC at the time of printing.

FIG. 22 shows an example of a detailed item setting window (default window).

FIG. 23 is a flowchart showing a sixth embodiment of the display control executed by the PC at the time of printing.

FIG. 24 shows an example of a window display of the display portion.

FIG. 25 shows an example of a window display of the display portion.

FIG. 26 shows an example of a window display of the display portion.

FIG. 27 shows an example of a window display of the display portion.

FIG. 28 shows an example of a window display of the display portion.

FIG. 29 shows an example of a window display of the display portion.

FIG. 30 shows an example of a window display of the display portion.

FIG. 31 shows an example of a window display of the display portion.

FIG. 32 is a flowchart showing a processing of changing a set value of an item which is transmissively displayed in the default window.

FIG. 33 shows an example of a window display of the display portion.

FIG. 34 shows another embodiment of a processing of changing a set value in a case where set values of a plurality of items are transmissively displayed in the default window.

FIG. 35 shows an example of a window display of the display portion.

FIG. 36 shows an example of a window display of the display portion.

### DETAILED DESCRIPTION OF THE PREFERRED EMBODIMENTS

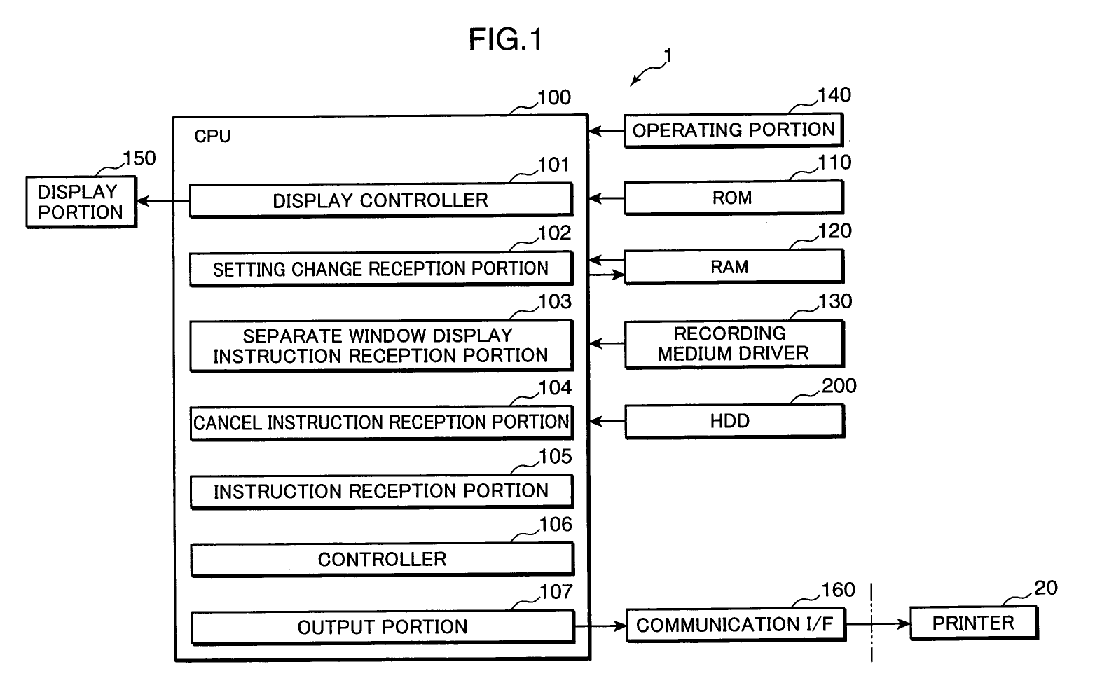

Hereinafter, embodiments of the present invention will be described with reference to the drawings. FIG. 1 is a block diagram showing a schematic configuration of a personal computer (hereinafter, referred to as PC) in which a display control program according to an embodiment of the present invention is installed.

PC 1 is connected to a printer 20 via a LAN (Local Area Network) cable, or a parallel cable such as a Centronics interface or a serial cable such as RS-232C, and the printer 20 prints on a recording sheet print data outputted from the PC 1. A communication I/F 160 serves as a LAN interface, a parallel I/F portion or a serial I/F portion. The printer 20 includes, in addition to a normal printer, various devices having a printer function such as a complex machine having a facsimile function, a printer function, and a copier function, and a facsimile apparatus.

The PC 1 includes, in addition to the communication I/F 160, a CPU100, a ROM (Read Only Memory) 110, a RAM (Random Access Memory) 120, a recording medium driver 130, an operating portion (input device) 140, a display portion 150 and an HDD 200.

The ROM 110 stores a BIOS (basic input/output system) which is a basic program for controlling peripheral devices such as the HDD 200 and the recording medium driver 130. The RAM 120 serves as a working area of the CPU 100 and temporarily stores various data. Under control of the CPU 100, the recording medium driver 130 reads out various data stored in a recording medium such as a CD-ROM, a flexible disk, and a DVD (Digital Versatile Disk).

The operating portion 140 includes a keyboard, a mouse, and the like. The operating portion 140 receives an operation command from a user and outputs an electric signal to the CPU 100 in accordance with the operation command. The display portion 150 includes a liquid crystal panel, a CRT (Cathode-Ray Tube) or the like and displays various images under control of the CPU 100.

The HDD 200 is composed of a magnetic disc or the like and stores an operating system, which is a basic program for integrally controlling the personal computer, and a display control program according to an embodiment of the present invention. This display control program allows the CPU 100 to execute a processing of allowing the display portion 150 to display an operation guide for an operator in accordance with an instruction inputted by an operator to a setting change reception portion 102 or the like. In a case where the display control program is recorded in a recording medium such as a CD-ROM and a flexible disk, the recording medium is loaded to the recording medium driver 130 and installed so that the display control program is stored into the HDD 200. Further, in a case where the display control program is stored in a web server on the internet, the display control program may be downloaded from the WEB server so that the program is stored into the HDD 200.

The CPU 100 executes the display control program under a control of the operating system to serve as a display controller 101, the setting change reception portion 102, a separate window display instruction reception portion (separate display instruction reception portion) 103, and a cancel instruction reception portion 104. Further, the CPU 100 also serves as an instruction reception portion 105, a controller 106, and an output portion 107.

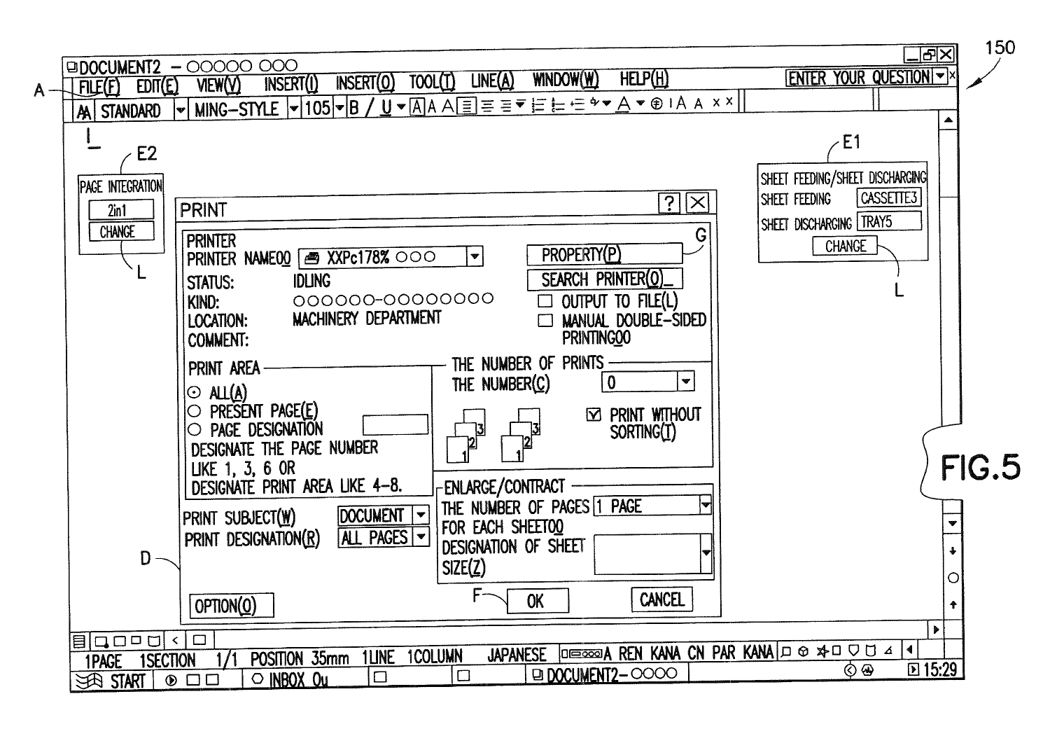

The display controller 101 controls a display operation of the display portion 150. The display controller 101 allows the display portion 150 to display an operation guide window presenting to an operator that set values of a plurality of items which are necessary for setting of a printing (a page layout, a designation of a sheet-feeding cassette, a scale printing, a print area and the like which are hereinafter referred to as items) are changeable in a form of, for example, a print operation guide window (FIG. 5) or the like which will be described hereinafter.

For example, the display controller 101 allows the display portion 150 to initially display a print operation guide screen (for example, in the window display shown in FIG. 5; hereinafter, as an example of the screen display, a case where a window display is adopted will be described; and other screen display will be described similarly in a form of window display) to present an operation guide to an operator. Thereafter, in accordance with an operation performed by an operator, the display controller 101 further allows the display portion 150 to switch the print operation guide window to other window such as a detailed item setting window. Specifically, the display controller 101 allows the display portion 150 to initially display the print operation guide window and then switch successively to a guide window (subordinate display windows) allocated at a lower hierarchical layer in accordance with an operation performed by an operator so that a window display of the display portion 150 is controlled to enable the operator to set detailed setting items which cannot be set in the initially displayed print operation guide window.

Further, when the display controller 101 allows the display portion 150 to display the print operation guide window, it allows the display portion 150 to display a predetermined item and its set value in a display frame (for example, in a window display) which is separate from the print operation guide window.

When the display controller 101 allows the display portion 150 to display the print operation guide window and a window of the lower hierarchical layer, the setting change reception portion 102 receives from an operator an instruction of changing a set value of an item. This instruction is inputted by an operator through the operating portion 140.

The separate window display instruction reception portion 103 receives from an operator an instruction of allowing the display portion 150 to display the item and its set value in the separate display frame (an example of a reception of the instruction will be described hereinafter). This instruction is inputted by an operator through the operating portion 140. When the separate window display instruction reception portion 103 receives an instruction of allowing the display portion 150 to display the item and its set value in the separate display frame, the display controller 101 allows the display portion 150 to display the received item and its set value in the separate display frame.

The cancel instruction reception portion 104 receives from an operator a cancelling instruction of cancelling the display of the item in the separate display frame. This instruction is inputted by an operator through the operating portion 140. The display controller 101 allows the display portion 150 to cancel the display of the item in the separate display frame in accordance the cancelling instruction received by the cancel instruction reception portion 104.

The instruction reception portion 105 receives various instructions regarding printing and the like inputted by an operator through the operating portion 140. The controller 106 controls an overall operation of the PC 1 and performs various controls necessary for a printing processing in accordance with an instruction inputted by an operator through the operating portion 140. Further, the output portion 107 outputs data applied with a data converting processing necessary for printing in an unillustrated printing data converting portion through the communication I/F 160 to the printer 20.

Further, a display device according to an embodiment of the present invention includes, for example, the display portion 150 and the CPU 100 (necessary functions among the display controller 101, the setting change reception portion 102, the separate window display instruction reception portion 103, the cancel instruction reception portion 104, and the instruction reception portion 105).

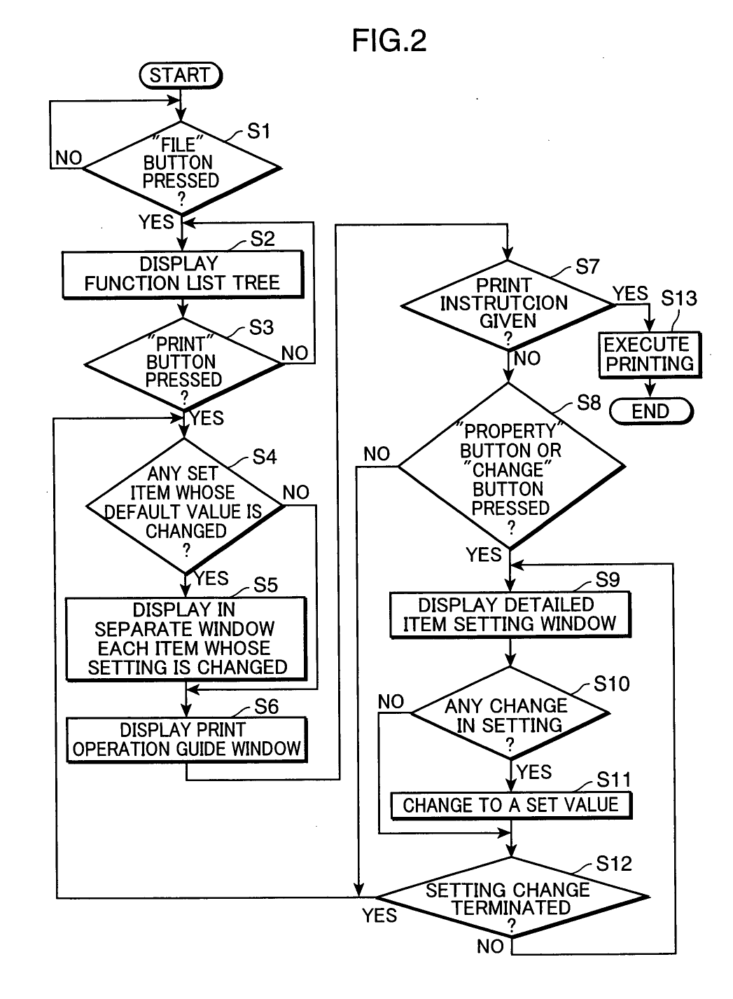

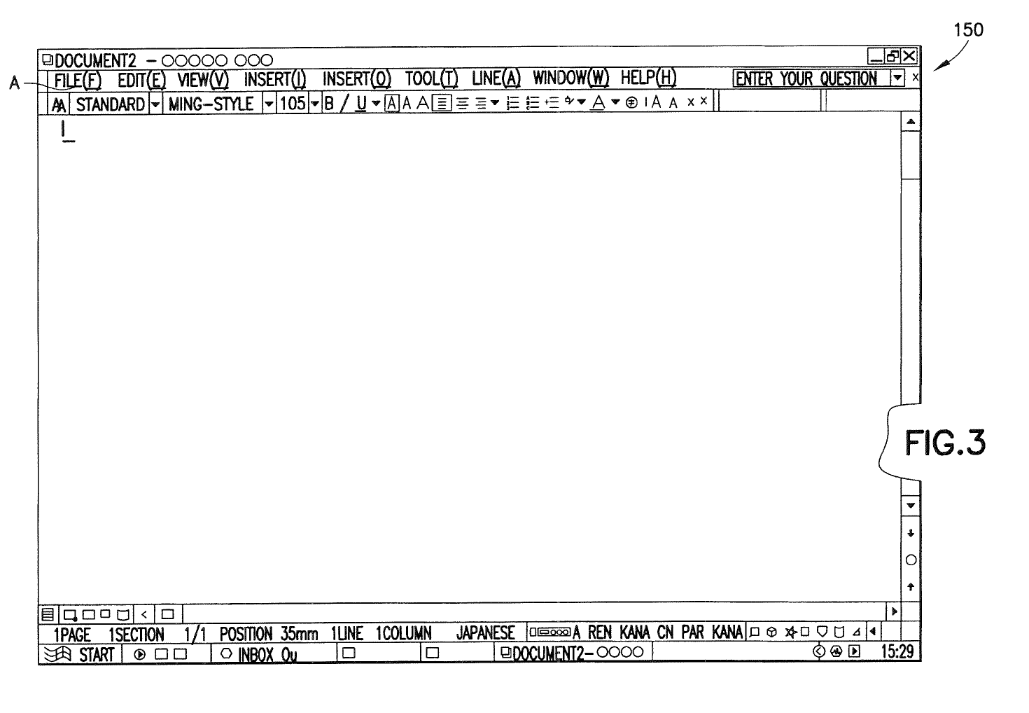

Next, a first embodiment of the display control executed at the time of printing by the PC 1 in which a display control program according to an embodiment of the present invention is installed will be described. FIG. 2 is a flowchart showing the first embodiment of the display control executed by the PC 1 at the time of printing. FIGS. 3 through 8 show examples of window displays of the display portion 150.

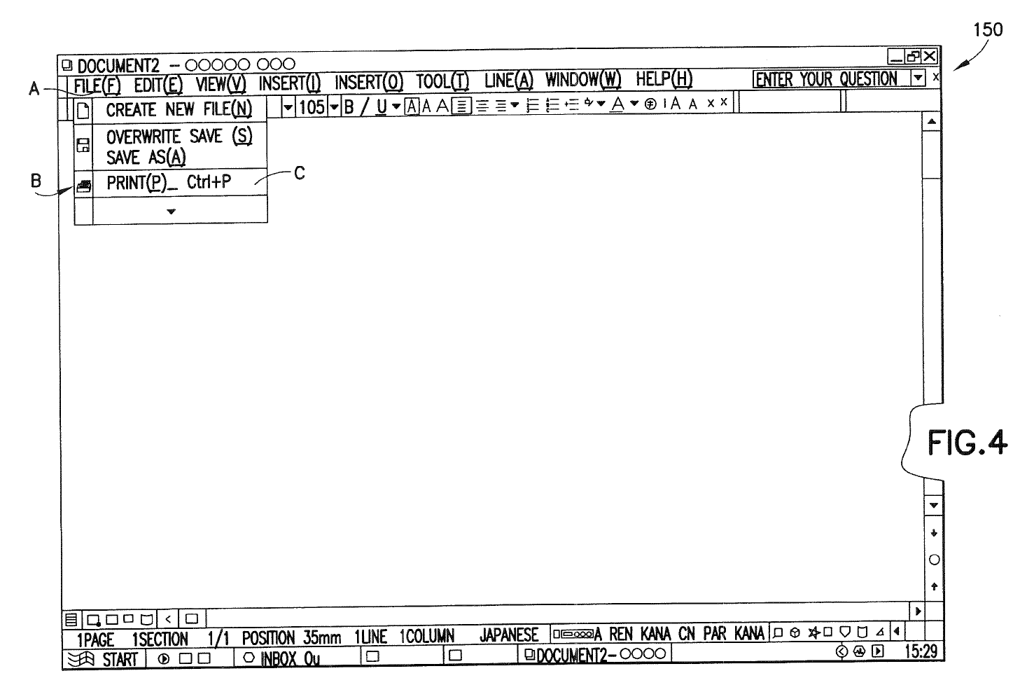

A state where the display portion 150 displays a word processing application will be described as an example. When an operator clicks (presses) with an operation of a mouse (operating portion 140) a “FILE” section A of the example of the window display shown in FIG. 3 and the instruction reception portion 105 receives an instruction of displaying a function list tree presenting executable functions (YES in S1), the display controller 101 allows the display portion 150 to display a function list tree B in a pull-down display (S2) as shown in FIG. 4.

When the operator operates the mouse and clicks a print button C of the function list tree B in a state where the display portion 150 displays the function list tree B, and the instruction reception portion 105 receives an instruction of displaying the print operation guide window (YES in S3), the display controller 101 determines whether or not any one of items which can be set by an operator (a page layout, a designation of a sheet feeding cassette, a scale printing, a print area and the like) has been changed from a default value (initial set value) in a printing operation executed previously (S4). The items which are subjected to the determination above are (1) both an item whose setting can be changed in a print operation guide window D (FIG. 5) described herebelow and an item which is called out from a window of a layer (subordinate display window) at a layer window allocated at further lower level from the print operation guide window D and whose set value can be changed in the lower layer window, or (2) only an item whose setting can be changed in the lower layer window.

When the display controller 101 determines that there exists an item which has been changed from a default value (YES in S4), the display controller 101 allows the display portion 150 to display the item having been changed from the default value along with a changed value in a window which is separate from the print operation guide window D (S5) and display the print operation guide window D also (S6). For example, as shown in FIG. 5, the display controller 101 allows the display portion 150 to display the print operation guide window D which is a first operation guide window at the time of printing operation along with windows E1, E2 presenting items presenting the default values have been changed. As described above, the windows E1, E2 which are displayed along with the print operation guide window D display items and their set values which can be changed only in layer windows which are at a hierarchical level lower than that of the print operation guide window D. Accordingly, the operator can confirm with the windows E1, E2 the items and their set values which are not displayed in the initially displayed print operation guide window D.

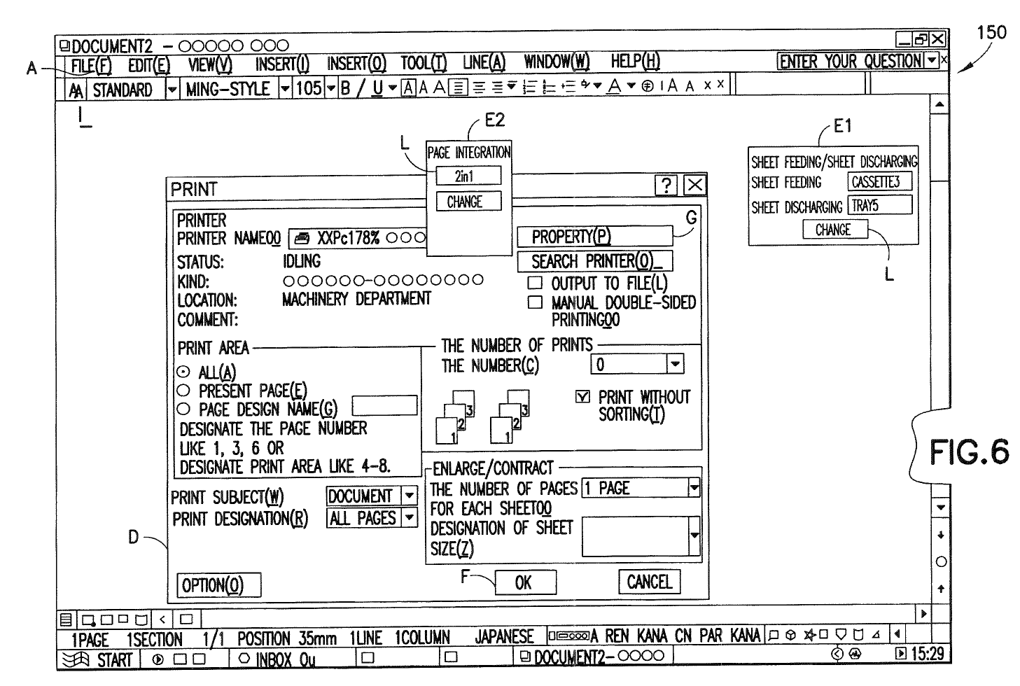

In FIG. 5, there is shown an example of a state where the display controller 101 allows the display portion 150 to display the windows E1, E2 at positions apart from the print operation guide window D. However, as shown in FIG. 6, the display controller 101 may allow the display controller 101 to display the window E1 or E2 such that the window E1 or E2 is in superimposition with the print operation guide window D. In such case, the print operation guide window D is partially hidden due to the superimposition of the window. However, the display controller 101 makes control to allow the window to be displayed in superimposition at an area of the print operation guide window D where a hiding of display does not cause a problem (for example, an area where numerals and keys are not displayed, and an area where numerals which have not been changed from the default value are displayed). Accordingly, any disadvantage of visibility and operability can be prevented from occurrence.

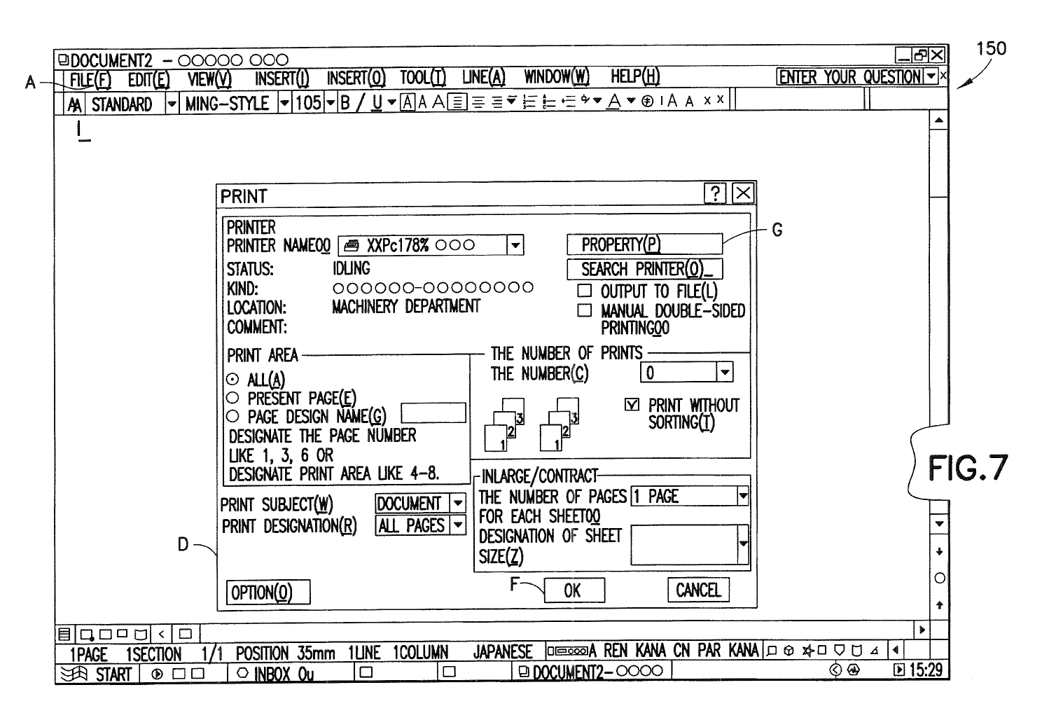

When the display controller 101 determines that there is no item changed from the default value (NO in S4), it skips the processing of S5 and allows the display portion 150 to display only the print operation guide window D as shown in FIG. 7, for example (S6).

Any one of the separate display processing of S4 and S5 and the print operation guide window display processing of S6 may be performed ahead. Further, when it is determined in S4 that a value is changed from the default value, the display controller 101 allows the display portion 150 to display the item and its set value in a window which is separate from the print operation guide window D. Alternatively, in S4, the display controller 101 may pick up the item whose set value is changed at the time of executing the previous printing processing and allow the display portion 150 to display the picked item and its set value thereof in the separate window.

When the operator operates the mouse and clicks an OK button F of the print operation guide window D in a state where the display portion 150 displays the print operation guide window D, and the instruction reception portion 105 receives a print instruction (YES in S7), the controller 106 executes a printing processing of print data in accordance with set values of items set at this point of time (S113).

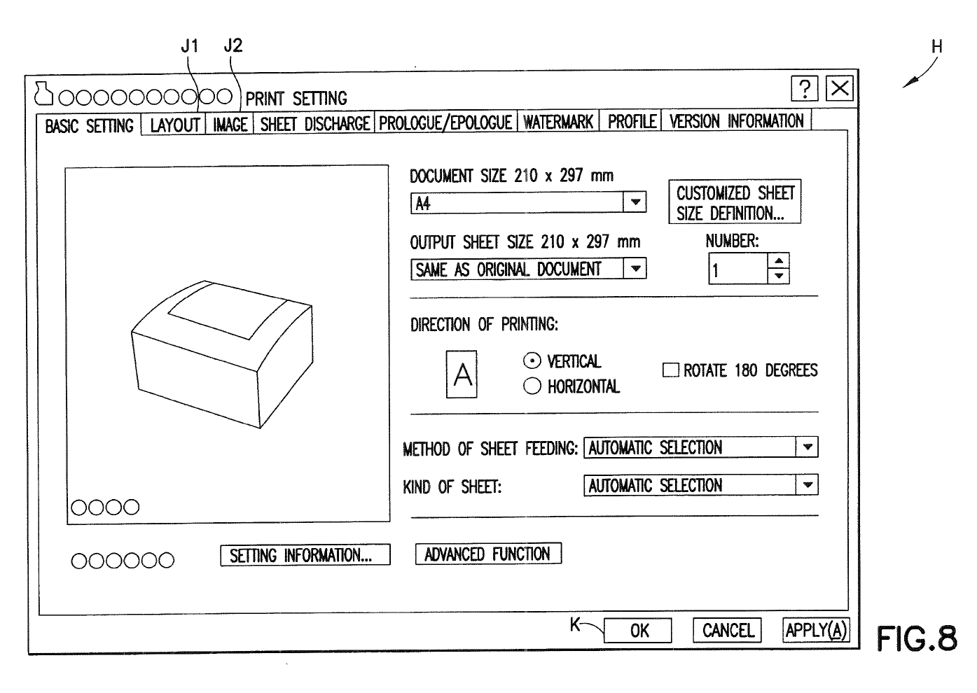

Further, when the operator does not click the OK button F but a property button G in a state where the print operation guide window D is displayed on the display portion 150, and the display controller 101 receives a display instruction of the detailed item setting window (NO in S7, YES in S8), the display controller 101 allows the display portion 150 to display a detailed item setting window H like the one shown in FIG. 8 (S9). The detailed item setting window H is operable to set items (a method of feeding a sheet, a kind of sheet, and the like) which cannot be changed in the initially displayed print operation guide window D. Further, when the operator operates the mouse and clicks tabs (a layout tab J1, an image tab J2, . . . ) displayed in an upper portion of the detailed item setting window H, the display controller 101 switches the display to another detailed item setting window which is operable to change settings of other items.

When the operator operates the mouse and changes a setting of any item, for example, a setting of a method of feeding a sheet, in a state where the detailed item setting window H is displayed, and the setting change reception portion 102 receives the setting change instruction (YES in S10), the controller 106 changes the value of the item whose setting has been changed to the value which is in accordance with an instruction from the operator (S11). The operator can change the setting of any one of the plurality of items in the detailed item setting window H until he operates the mouse and clicks an OK button K (NO in S12).

When the operator operates the mouse and clicks the OK button in a state where the detailed item setting window H is displayed (YES in S12), the routine goes back to S4. Then, the display controller 101 allows the display portion 150 to display the print operation guide window D and/or the windows E1, E2 again (S4 through S6).

Further, as shown in FIG. 5, change buttons L are displayed respectively in the separate windows E1, E2. When the operator operates the mouse and presses the change button L, the display controller 101 receives an instruction of displaying the detailed item setting window H (YES in S8). Then, the display controller 101 allows the display portion 150 to display the detailed item setting window H (S9). Thus, the operator can switch the window display of the display portion 150 to the detailed item setting window H also by pressing the change button L of the separate window to set items which cannot be changed in the print operation guide window. When the operator presses the change button L, the display controller 101 allows the display portion 150 to display the detailed item setting window H whose set values of items presented by the window in which the change button L are changeable.

As described above, according to the display control, the items which are changed from the default values are displayed respectively in the windows E1, E2 which are separate from the print operation guide window D when the initially displayed print operation guide window D is displayed. Accordingly, the operator can easily grasp items whose default values have been changed and the changed value.

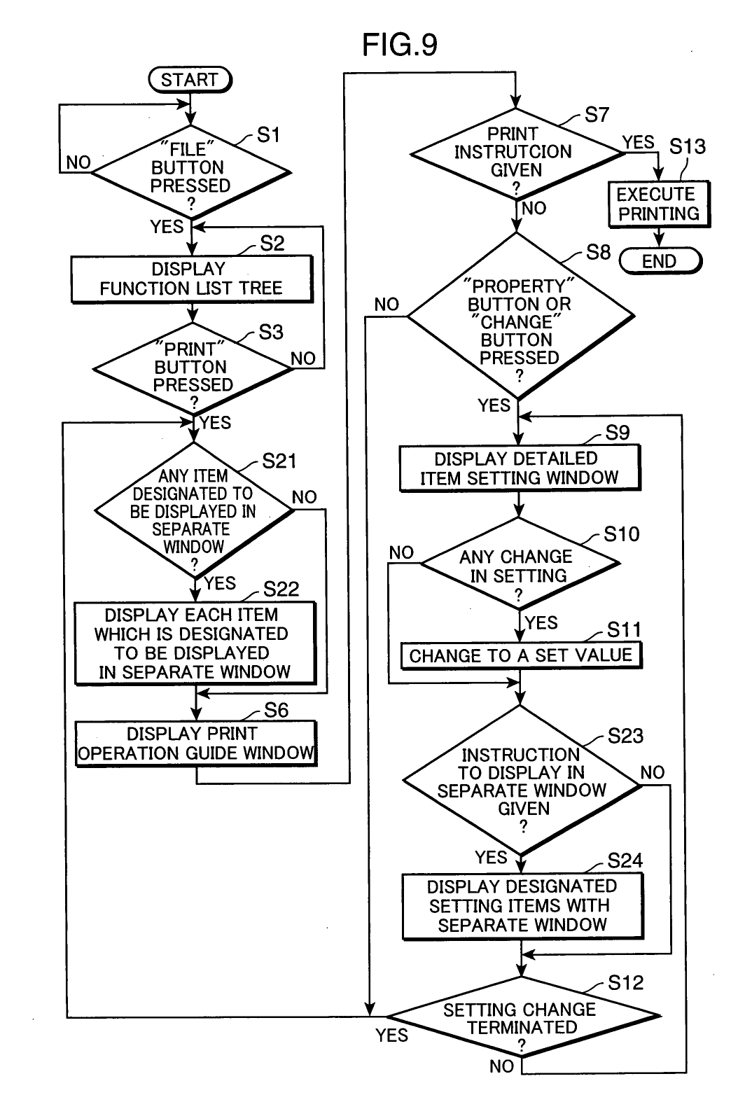

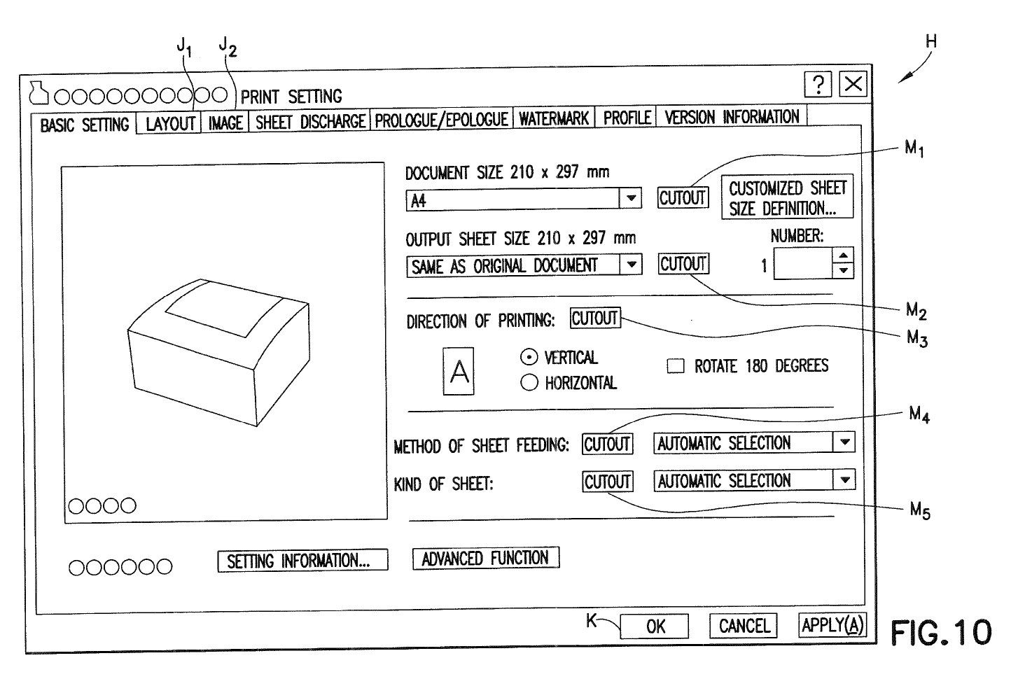

Next, a second embodiment of a display control executed at the time of printing by the PC 1 in which the display control program according to an embodiment of the present invention is installed will be described. FIG. 9 is a flowchart showing the second embodiment of the display control executed by the PC 1 at the time of printing. FIG. 10 shows an example of a detailed item setting window. It should be noted that the processing which is substantially the same as that shown in FIG. 2 are provided with the same reference signs and descriptions of the processing will be omitted.

In the embodiment 1, the display controller 101 determines items whose respective values are changed from the default value and then allows the display portion 150 to display the items whose respective values are changed from the default values in the separate windows E1, E2. However, in the second embodiment, the display controller 101 allows the display portion 150 to display items designated by an operator in a window which is separate from the print operation guide window D.

When the instruction reception portion 105 receives an instruction of displaying the print operation guide window D (YES in S3), the display controller 101 determines whether or not the separate window display instruction reception portion 103 receives an instruction of allowing the display portion 150 to display in the separate display frame i.e. whether or not there is an item which should be displayed in the window separate from the print operation guide window D in accordance with an instruction inputted through an operation (S21). Here, when the display controller 101 determines that there is an item which should be displayed in a separate window (YES in S21), it allows the display portion 150 to display in a window separate from the print operation guide window D the item designated to be displayed in the separate window (S22), as shown in FIG. 5 for example.

The setting of an instruction of displaying in a separate window will be described. When the display controller 101 allows the display portion 150 to display the detailed item setting window H (S9), cutout keys M1 through M5 are displayed near items respectively as shown in FIG. 10 for example. When the operator operates the mouse and clicks any one of the cutout keys M1 through M5, the separate window display instruction reception portion 103 receives an instruction of displaying the item corresponding to the clicked cutout key in a separate window. Then, when the separate window display instruction reception portion 103 receives the instruction (YES in S23), the designated item is displayed in the separate window (S24).

In the present embodiment, when the separate window display instruction reception portion 103 receives an instruction of displaying in the separate window, the designated item is expeditiously displayed in a window separate from the detailed item setting window H. However, when the window display of S24 is not performed and the print operation guide window D is displayed at the next time, the display controller 101 may determine whether or not there is an item which is set to be displayed in the separate window and then allow the display portion 150 to display in a window separate from the print operation guide window D the item designated to be displayed in the separate window (S21, S22, S6).

According to this display control, the operator can allow a desired item to be displayed in the window separate from the print operation guide window D regardless of whether or not the default value is changed. Accordingly, it becomes easy for an operator to grasp setting of a desired item.

Further, another form of a method for an operator to give an instruction of displaying in a separate window shown in S23 can be adopted. For example, when the operator moves a mouse pointer and the like as the operating portion 140 of the PC 1 onto a display part of a set value which should be displayed in a separate window to drag the display part to an outer area from the print operation guide window D, the separate window display instruction reception portion 103 may receive a set value to be displayed in a separate window and a display position of the separate window which are designated by the dragging operation and the display controller 101 may allow the display portion 150 to display the set value in a separate window at the display position.

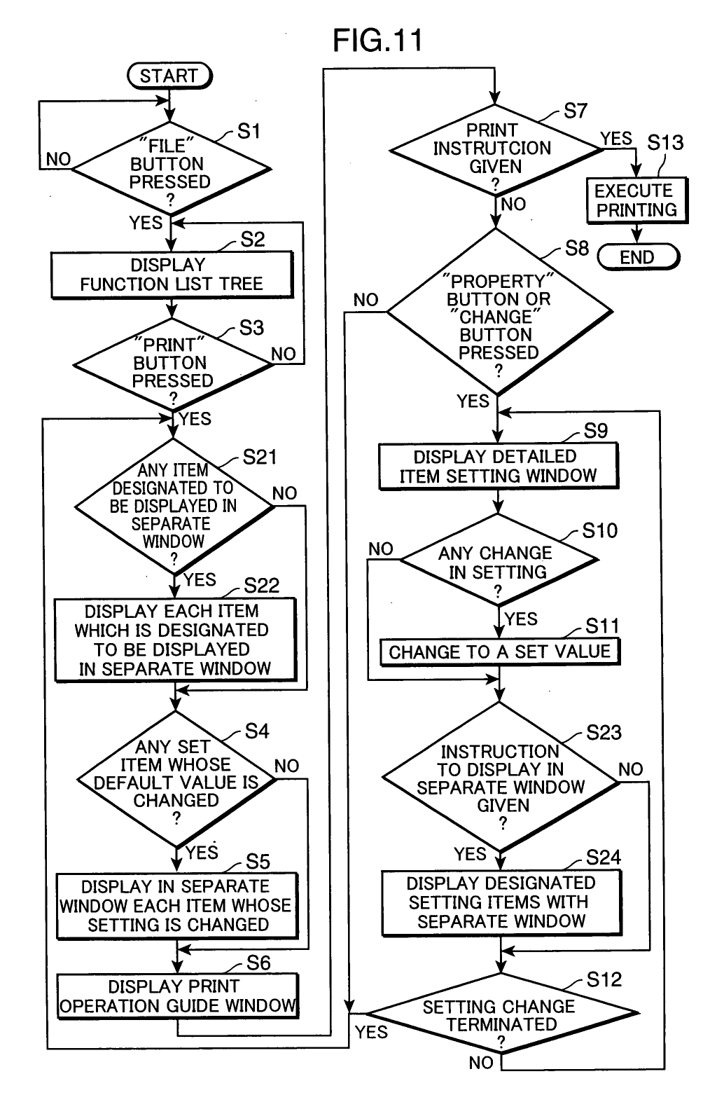

Next, a third embodiment of the display control executed at the time of printing by the PC 1 in which a display control program according to an embodiment of the present invention is installed will be described. FIG. 11 is a flowchart showing the third embodiment of a display control executed by the PC1 at the time of printing. Processing which are substantially the same as those of the first and second embodiments shown in FIGS. 2 and 9 are provided with the same reference signs and descriptions of the processing will be omitted.

As described above, in the first embodiment, the display controller 101 allows the display portion 150 to display in a window separate from the print operation guide window D the items whose default values are changed, and in the second embodiment, the display controller 101 allows the display portion 150 to display in a window separate from the print operation guide window D the item designated by the operator. On the other hand, in the third embodiment, the display controller 101 performs both of these.

Specifically, when the instruction reception portion 105 receives an instruction of displaying the print operation guide window D (YES in S3), the display controller 101 performs both a determination of whether or not there is an item which is displayed in a window separate from the print operation guide window D in accordance with an operator's instruction (S21) and a determination of whether or not there is an item whose default value is changed (S4). Then, the display controller 101 allows the display portion 150 to display in a window separate from the print operation guide window D any one of the items set to be displayed in a separate window and the item whose default value is changed (S21, S22, S4,S5).

According to this display control, the display portion 150 displays both the item whose default value is changed and the item which is set by the operator to be displayed in a separate window. Accordingly, it further becomes easy for the operator to grasp a set value of an item.

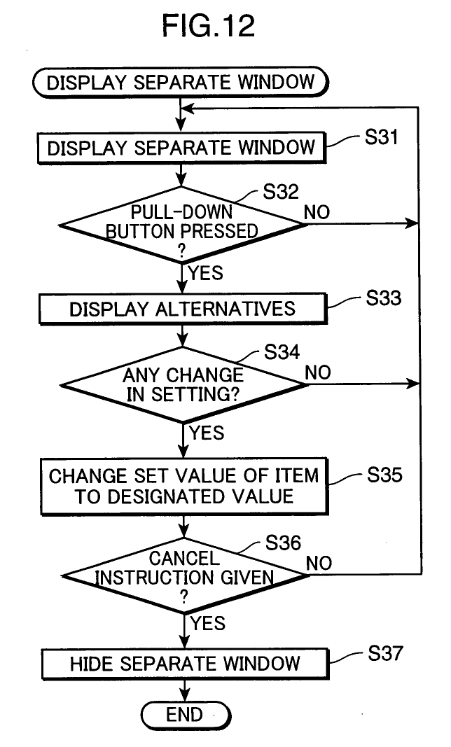

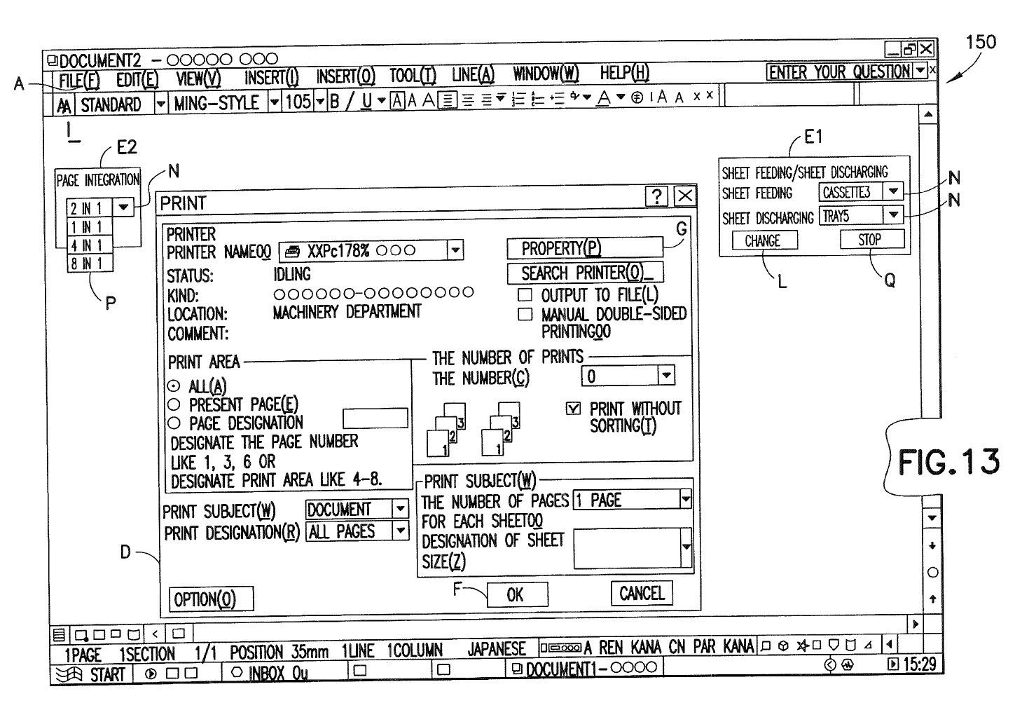

Next, a processing of changing an item set value in a window separate from the print operation guide window will be described. FIG. 12 is a flowchart showing a processing of changing the item set value in a separate window. FIG. 13 shows an example of a window display of the display portion 150.

According to the separate windows described respectively in the above-described embodiments, the display controller 101 allows the display portion 150 to display the detailed item setting window H when an operator operates the mouse and clicks a change button L (FIG. 5) such as a window E1. A set value of an item presented with the window E1 and the like can be changed in the detailed item setting window H. However, a set value of a displayed item may be changed in the separate window E1 and the like as will be described herebelow.

The display controller 101 allows pull-down buttons N to be displayed in the windows E1, E2 respectively as shown in FIG. 13 for example when it allows the display portion 150 to display predetermined items and their set values in the separate windows (S31). When the operator operates the mouse and clicks the pull-down button N to give an instruction of displaying alternate values (YES in S32), the display controller 101 allows the display portion 150 to display a plurality of alternate values of the set value to in the pull-down display P (S33). Here, when the operator operates the mouse and clicks a part presenting a value to be newly set among the plurality of alternative values to give an instruction of changing the value (YES in S34), the controller 106 changes the set value of the item to the designated value (S35).

Accordingly, the operator can change a set value of an item displayed in the window by operating the pull-down button N. Therefore, for example, the operator does not have to perform operations of the print operation guide window D and the detailed item setting window H which is an operation window allocated at further lower hierarchical layer. Consequently, operability further improves.

Further, when an operator operates the mouse and clicks a cancel button Q which is displayed in each of the windows E1, E2 by the display controller 101, the cancel instruction reception portion 104 receives an instruction of hiding a window having the clicked cancel button Q (YES in S36). When the cancel instruction reception portion 104 receives this hiding instruction, the display controller 101 hides the window having the clicked cancel button (S37). Accordingly, an operator can desirably switch the window to be displayed and hidden.

When the display controller 101 executes a display control of displaying and hiding the window in accordance with whether or not the default value of the item is changed or the set value of the item is changed in the previously executed printing processing (first and third embodiment), it may hide the window without executing processing of S36 and S37 if the set value of the item is restored to the default value or if the set value is restored to a state where a set value has not been changed in the previously executed printing processing.

In the embodiment described above, when the display controller 101 allows the display portion 150 to display the print operation guide window, it allows the display portion 150 to display a set value of the item in a separate display frame (for example, a window). However, the display controller 101 may allow the display portion 150 to display a plurality of items and their set values collectively in one window.

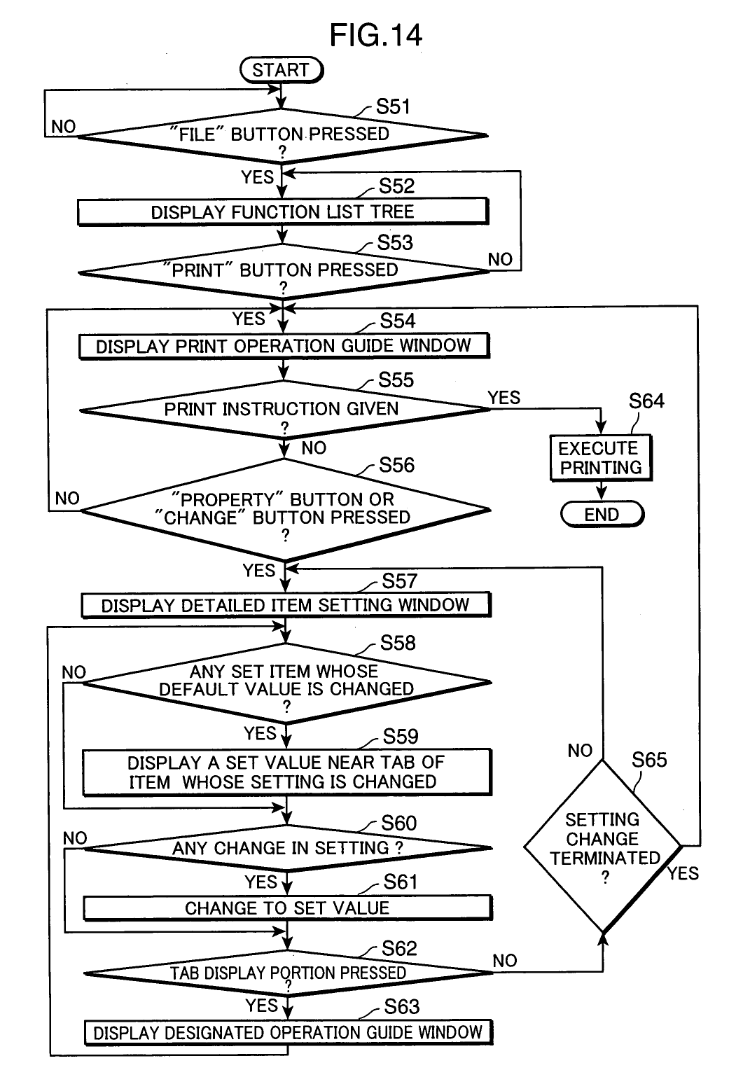

Next, a fourth embodiment of a display control executed at the time of printing by the PC 1 in which the display control program according to an embodiment of the present invention is installed will be described. FIG. 14 is a flowchart showing the fourth embodiment of a display control executed by the PC 1 at the time of printing. An example of the detailed item setting window is as shown in FIG. 10.

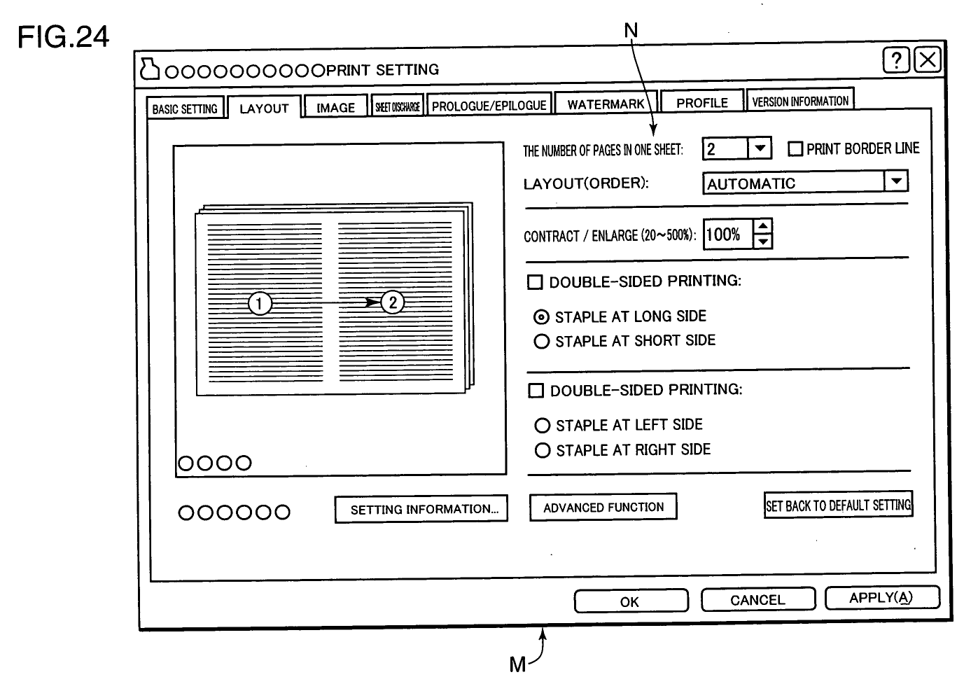

In the fourth embodiment, the display controller 101 (FIG. 1) allows the display portion 150 to display a default window which is initially displayed as the detailed item setting window and a second window which is operable to change at least one of a set value of one or more items and displayed when switched from the default window. For example, as shown in FIG. 8 mentioned above, the display controller 101 allows the display portion 150 to display a so-called tab in the detailed item setting window H displayed as the default window to present that the window can be switched to the second window. The display controller 101 switches the display to the second window (for example, refer to FIG. 24) when the tab display part of the detailed item setting window H is designated with a mouse pointer or the like which serves as the operating portion 140. The second window is operable to set various items which are different from those displayed in the detailed item setting window H. On the other hand, a display window allocated at a hierarchical layer lower than the detailed item setting window H (for example, the display window which is displayed when the “application function” button shown in FIG. 6 is designated with a mouse pointer or the like) is displayed as a window which is operable to set details of the items which are set in the detailed item setting window H.

Further, when the display controller 101 allows the display portion 150 to display in the detailed item setting window H a set value of the item set in the second window, the cancel instruction reception portion 104 (FIG. 1) receives from an operator a cancel instruction of cancelling a display of the set value. The display controller 101 cancels displaying of the set value in accordance with the cancel instruction received by the cancel instruction reception portion 104.

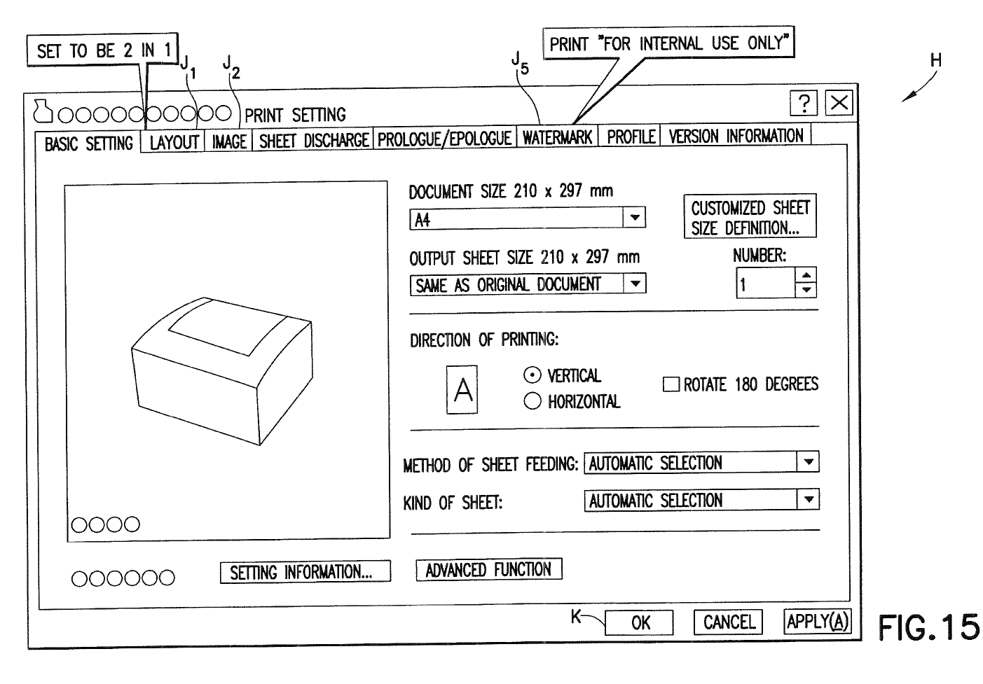

A fourth embodiment of the display control executed at the time of printing by the PC 1 in which a display control program according to an embodiment of the present invention will be described with reference to the drawings. FIGS. 15 through 18 show examples of window displays of the display portion 150. Detailed descriptions of the processing similar to that of the first through third embodiments will be omitted.

Similarly to the first through third embodiments, an example of a state where the display portion 150 displays a word processing application will be described. When an operator operates a mouse (operating portion 140) and clicks (presses) the “FILE” column A of the example of the window display shown in FIG. 3 to give an instruction of displaying a function list tree presenting executable functions to the instruction reception portion 105 (YES in S51), the display controller 101 allows the display portion 150 to display the function list tree B as shown in FIG. 4 (S52).

When the operator operates the mouse and clicks a print button C of the function list tree B in a state where the display portion 150 displays the function list tree B, and the instruction reception portion 105 receives an instruction to display a print operation guide window (YES in S53), the display controller 101 allows the display portion 150 to display a print operation guide window D like the one shown in FIG. 7 (S54).

When the operator operates the mouse and clicks the OK button F of the print operation guide window D in a state where the display portion 150 displays the print operation guide window D, and the instruction reception portion 105 receives a print instruction (YES in S55), the controller 106 executes a processing of printing subject print data in accordance with a set value of each item set at this point of time (S64).

Further, when the operator does not click the OK button F but a property button G in a state where the display portion 150 displays the print operation guide window D, and then the display controller 101 receives an instruction of displaying the detailed item setting window (NO in S55, YES in S56), the display controller 101 allows the display portion 150 to display the detailed item setting window H like the one shown in FIG. 8 as the above-described default window (S57). The detailed item setting window H is operable to set items (a sheet feeding method, a kind of sheet, and the like) which cannot be changed in the initially displayed print operation guide window D. Further, when the operator operates the mouse to click a tab (a layout tab J1, an image tab J2, . . . ) displayed in an upper portion of the detailed item setting window H, the display controller 101 allows the display portion 150 to switch its display to yet another detailed item setting window in which each setting of a respective item can be changed.

Then, the display controller 101 determines whether or not the item (such as a page layout (2in1 and the like), a background printing, and the like) which cannot be set by an operator at that point of time but can be set when the operator presses any of the layout tab J1, the image tab J2, and etc. to allow the display portion 150 to display another detailed item setting window as a second window (S58) is changed from the default value (initial set value) in previous printing operations.

When the display controller 101 determines that there is an item whose set value is changed from the default value (YES in S58), it allows the display portion 150 to display the value which is set at this point of time near a tab display part corresponding to the detailed item setting window which is operable to change a setting of item whose default value has been changed (S59).

For example, as shown in FIG. 15, when a print layout is changed from 1in1 of the default value to the 2in1, the display controller 101 allows the display portion 150 to present “SET TO BE 2in1” near the layout tab J1 corresponding to the window which is operable to change setting of the item of the print layout. Further, when the background printing is changed from the default value of “NO BACKGROUND” to the printing of “FOR INTERNAL USE ONLY”, the display controller 101 allows the display portion 150 to display “PRINT “FOR INTERNAL USE ONLY”” near a watermark tab J5 corresponding to the window which is operable to change setting of the item for the background printing. When a plurality of items are changed from the default values, the display controller 101 allows the display portion 150 to display respective set values of the items. Accordingly, the operator can confirm the set value, which cannot be set or confirmed in the currently displayed detailed item setting window, without performing an operation of displaying another detailed item setting window which is operable to set the item.

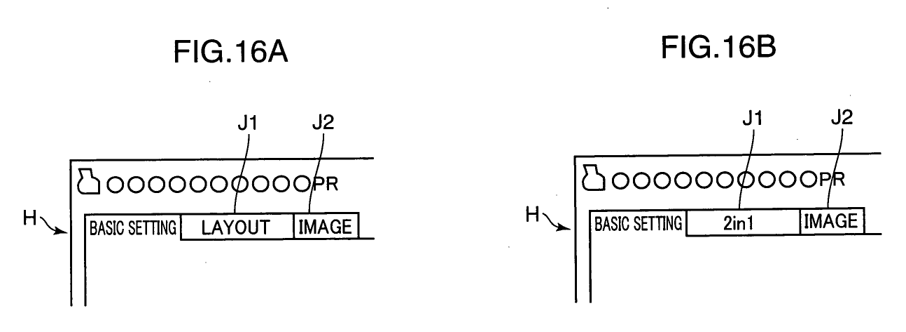

The set values of the above-described items may be displayed in such manners as shown in FIGS. 16A, 16B. The display controller 101 allows the display portion 150 to display “LAYOUT” in a display part of the layout tab J1, which is a guide to a second window, as shown in FIG. 16A, and then switches the display in the display part to “2in1” showing a setting of the item as shown in FIG. 16B when a predetermined time (for example, 0.5 seconds) passes. When a predetermined time (0.5 seconds) passes further, the display controller 101 switches the display in the display part to “LAYOUT.” The display controller 101 repeats the processing. In this case, the display controller 101 desirably reads out necessary still image data from a data storing area of the HDD 200 and allows the display portion 150 to display the above-described content.

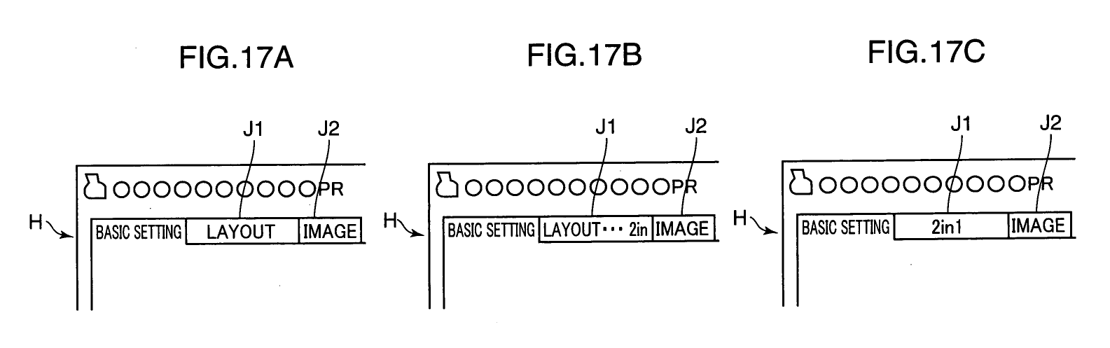

Further, the set values of the above-described items may be displayed in such manners as shown in FIGS. 17A, 17B, 17C. The display controller 101 may allow the display portion 150 to display the item in scrolling display in the display part of the layout tab J1, which is a guide to the second window, as shown in FIG. 17A. For example, as shown in FIG. 17A, the display controller 101 allows the display portion 150 to display “LAYOUT” in the display part of the layout tab J1 which is a guide to the second window. Then, as shown in FIG. 17B, the display controller 101 gradually deletes the display of “LAYOUT” from the left end in FIG. 17B as time passes by, and starts displaying of “2in1” from the right end. After switching the display to “2in1”, the display controller 101 allows the display portion 150 to delete the displaying of “2in1” from the left end like the above, and starts the displaying of “LAYOUT” from the right end. Thereafter, the same processing is repeated. In this case, the display controller 101 reads out necessary motion image data from a display image data storing area of the HDD 200 and plays the same to allow the display portion 150 to display the above-described content. The display controller 101 allows the scrolling display to be executed not only in a horizontal direction as described above but also in other direction such as a vertical direction alternatively.

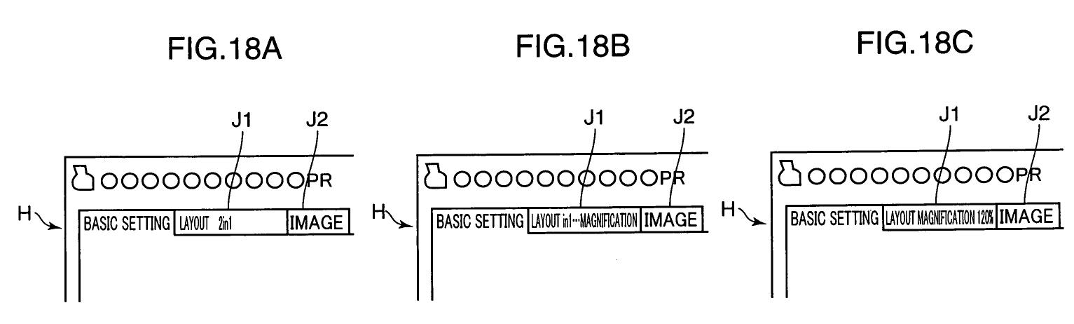

Further, as shown in FIGS. 18A, 18B, 18C, the display controller 101 may allow the display portion 150 to fixedly display a part of the item to be displayed in the display part in the display part of the layout tab J1 which is a guide to the second window (for example, “LAYOUT” which serves as a switching guide to the second window) and allow the item other than this (for example, “2in1” and “MAGNIFICATION 120%) to be displayed in the scrolling display. For example, as shown in FIG. 18A, the display controller 101 allows the display of “LAYOUT” to be fixed in the display part of the layout tab J1 which serves as a guide to the second window, and gradually deletes the display part of “2in1” from the left end as shown in FIGS. 18A, 18B with passage of time. Then, together with this, the display controller 101 starts displaying of “MAGNIFICATION 120%.” After switching to the displaying of “MAGNIFICATION 120%”, the display controller 101 deletes the displaying of “MAGNIFICATION 120%” from its left end and starts the displaying of “2in1” from the right end. Thereafter, the same processing is executed repeatedly. In this case, the display controller 101 reads out motion image data from the display image data storing area of the HDD 200 to allow the display portion 150 to display the content described above. The display controller 101 may allow the scrolling display to be executed not only in a horizontal direction as described above but also in other direction such as a vertical direction.

Further, in the embodiments of displaying set values of the items described above, the display controller 101 may enlarge the tab display part of the second window having a changed item and allow the same to be larger than other tabs.

The display controller 101 skips the processing of S59 when it determines that there is no item which is changed from the default value (NO in S58).

Any one of the processing in S58 and S59 and the displaying processing of the detailed item setting window H in S57 may be performed ahead. Further, in S58, the display controller 101 displays a set value of an item which is changed from the default value near the tab display part corresponding to a window which is operable to set the item. Alternatively, in S58, the display controller 101 may determine whether or not there is an item whose set value is changed at the time of previous printing processing and display the set value of the item whose set value is changed near the tab display part corresponding to a window which is operable to change the setting of the item.

When the detailed item setting window H is displayed and an operator operates a mouse pointer to change a setting of a sheet feeding method and setting of any one of the items and give the setting change instruction to the setting change reception portion 102 (YES in S60), the controller 106 changes the changed item to a value in accordance with the instruction from the operator (S61) and stores the same. The set change of the item in the detailed item setting window H can be made to a plurality of items until the operator operates the mouse to click the OK button K. (S57, NO in S62, NO in S65).

When the detailed item setting window H is displayed and the operator operates the mouse to click the OK button (YES in S65), the routine goes back to S54, and the display controller 101 allows the display portion 150 to display the print operation guide window D again.

Further, when the operator operates a mouse to click any one of the tabs (layout tab J1, image tab J2 . . . ) which are displayed in an upper portion of the detailed item setting window H (YES in S62), the display controller 101 allows the display portion 150 to switch the display to another detailed item setting window (second window or default window) which is operable to change setting of other item (S63). Thereafter, the routine goes back to S58. Then, the display controller 101 executes the processing of S58 through S62 after switching the display to another detailed item setting window. In other words, the display controller 101 allows the display portion 150 to display the set value which is changed from the default value in a different detailed item setting window after switching the display to the another detailed item setting window.

As described above, according to the display control, an operator can easily grasp a set value of the item whose set value cannot be changed in other detailed item setting window at the time when the detailed item setting window is displayed without performing an operation of switching to the other detailed items setting window.

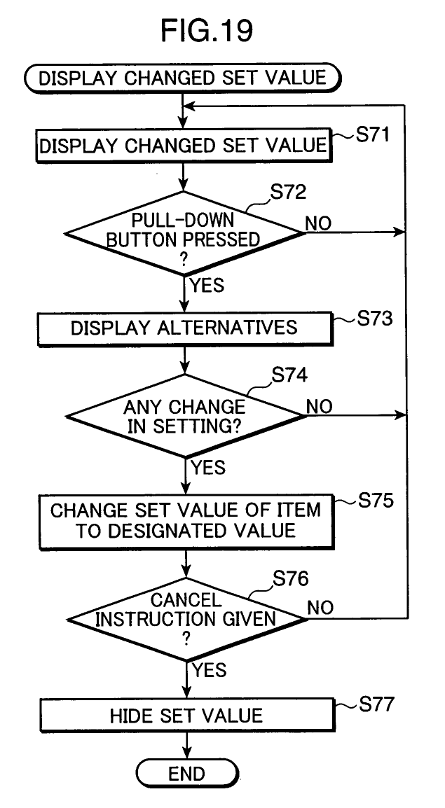

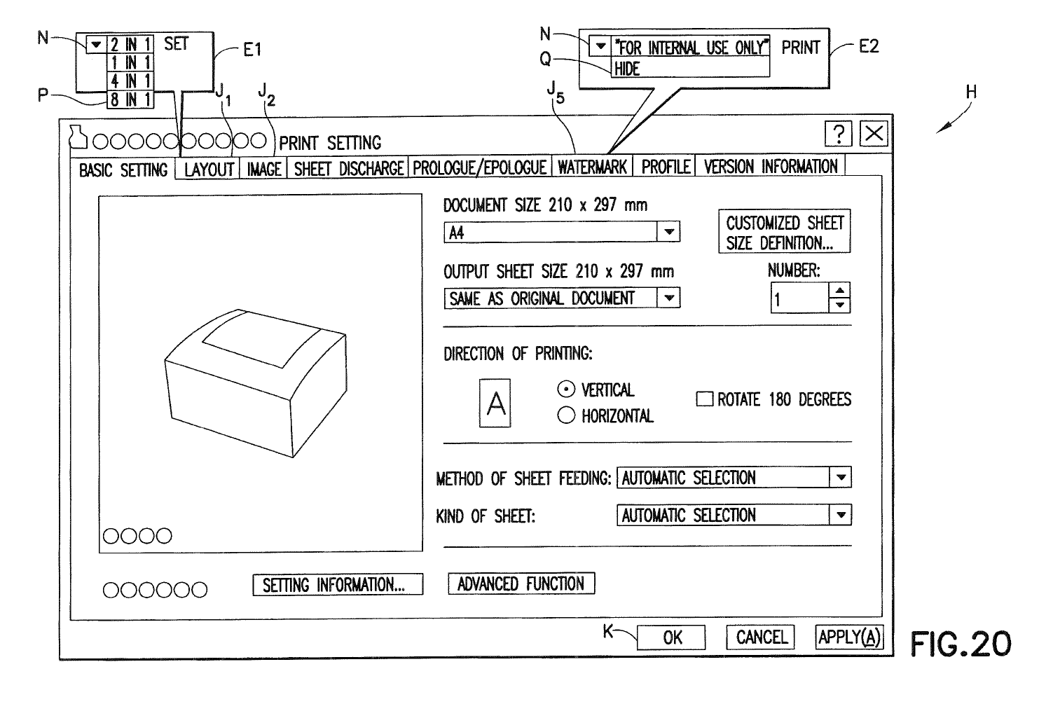

Next, another embodiment of a processing of changing the set value of an item of the detailed item setting window displayed near the tab display part in the detailed item setting window displayed will be described. FIG. 19 is a flowchart showing other embodiment of a processing of changing a set value of an item in the detailed item setting window. FIG. 20 shows an example of a window display of the display portion 150.

In the fourth embodiment, when the operator would like to change the set value of an item of other detailed item setting window (second window) displayed near a tab display part in the detailed item setting window H which is the default window, the operator operates a mouse to click a tab display part of the detailed item setting window (second window) corresponding to the item of the set value to switch to the detailed item setting window. The operator has to perform an operation of changing the set value of the item which should be changed in the switched detailed item setting window of the second window. With respect to this, a modified example of the fourth embodiment described herebelow enables the operator to change the displayed set value just by operating a mouse with the set value display part near the tab display part.

The display controller 101 allows the display portion 150 to display pull-down buttons N respectively in the set value display frames E1, E2 as shown in FIG. 20 when it allows the set value of the other detailed item setting window (second window) near the tab display part in the detailed item setting window (S71). When the operator operates the mouse to click the pull-down button N and the setting change reception portion 102 receives an instruction to display alternate values (YES in S72), the display controller 101 allows the display portion 150 to display a plurality of alternate values for the set value in the pull-down display P, for example (S73). Here, when the operator operates the mouse to click a part displaying a value which is to be newly set among the plurality of alternate values and the setting change reception portion 102 receives an instruction of changing the value (YES in S74), the controller 106 changes the set value of the item to a designated value (S75).

Accordingly, the operator can change the set value of items displayed respectively in the set value display frames E1, E2 by operating the pull-down button N without performing an operation of switching to other detailed item setting window. Therefore, operability further improves.

Further, when the operator operates the mouse to click a hiding button Q allowed to be displayed by the display controller 101 in each of the set value display frames E1, E2, the cancel instruction reception portion 104 receives an instruction of hiding the set value display frame through the hiding button Q clicked by the operator (YES in S76). When the cancel instruction reception portion 104 receives the hiding instruction, the display controller 101 hides the set value display frame of the clicked hiding button Q (S77). Therefore, the operator can switch the displaying and hiding of the set value display frame when necessary.

Since the display controller 101 executes the display control of displaying or not the set value display frame in accordance with the item whose default value is changed or the item whose set value is changed at the time of executing the previous printing processing, the display controller 101 may allow the display frame to be hidden regardless of the processing in S76 and S77 when the set value of the item is changed to the default value or a status is shifted to a state where the set value has not been changed at the time of executing the previous printing processing.

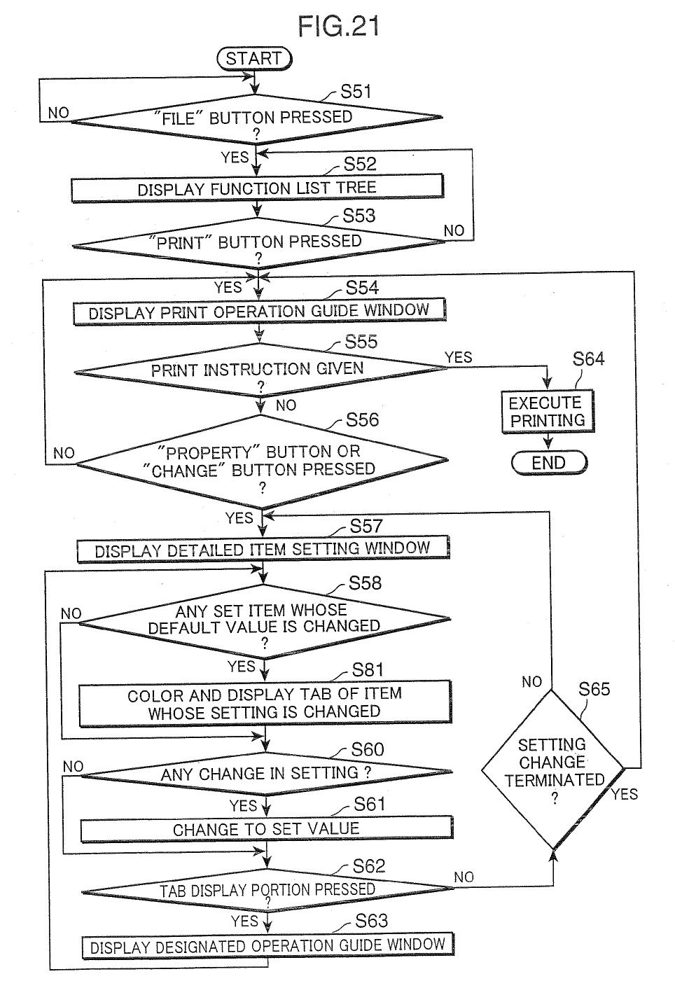

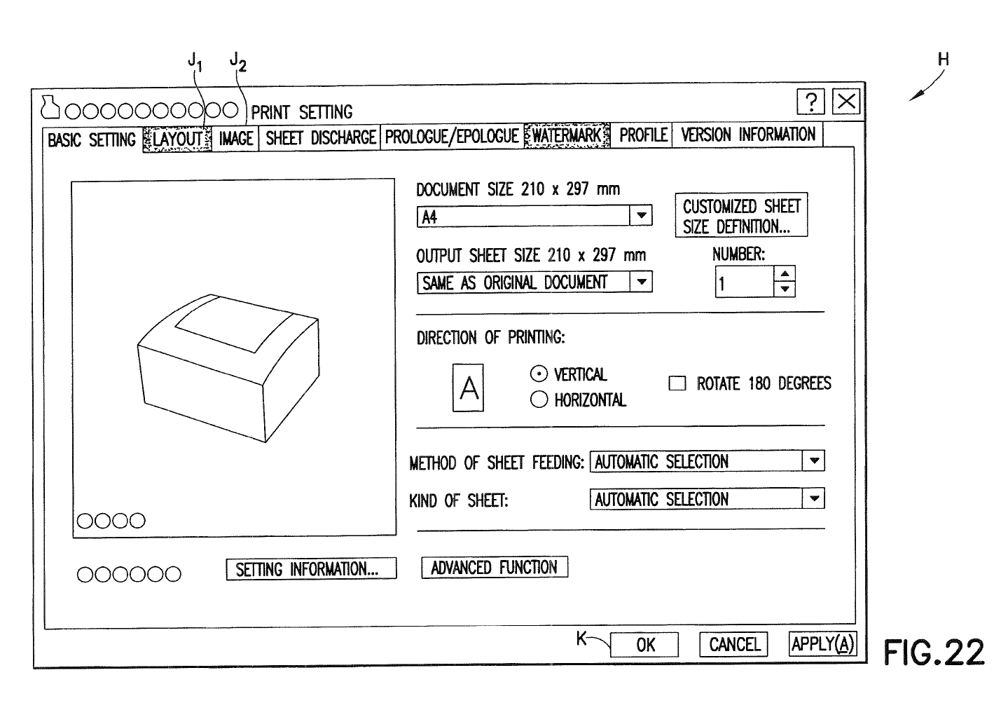

Next, a fifth embodiment of a display control at the time of printing by the PC 1 in which a display control program according to one embodiment of the present invention is installed will be described. FIG. 21 is a flowchart showing a fifth embodiment of the display control executed by the PC 1 at the time of printing. FIG. 22 shows an example of the detailed item setting window (default window). The processing similar to that of the fourth embodiment shown in FIG. 14 is provided with the same reference signs and their detailed descriptions will be omitted.

In the fourth embodiment, when the initial detailed item setting window (default window) is displayed and at least one of items in other detailed item setting window (second window) is changed from its or their default value, the display controller 101 allows the display portion 150 to display the changed set value, which is changed in the initial detailed item setting window (default window), near a tab display part corresponding to the detailed item setting window (second window) whose item is changed. However, in the fifth embodiment, the display controller 101 displays a corresponding tab display part with a color which is different from those in other tab display parts in the detailed item setting window.

In other words, when the initial detailed item setting window (default window) is displayed (S57) and the display controller 101 determines that there is an item which is changed from the default value (or an item which is changed at the time of executing the previous printing processing) (YES in S58), the display controller 101 allows the display portion 150 to differ a color of a tab display part, which corresponds to the detailed item setting window which is changed from the default value, from other tab display parts (S81) as shown in FIG. 22. Accordingly, the operator can easily recognize that a set value of at least one of items of the detailed item setting window corresponding to the discolored tab is changed from the default value or that the set value is changed at the time of executing the previous printing processing. Further, the display controller 101 may allow a tab display part corresponding to the detailed item setting window which is operable to change setting of an item whose default value is changed to be displayed in a display form with a bold frame, a half-tone dot meshing, enlargement and the like so as to be different from other tab display part.

The display devices executing the display control according to the fourth and fifth embodiments include, for example, the display portion 150 and the CPU 100 (necessary functions among the display controller 101, the setting change reception portion 102, the cancel instruction reception portion 104, the instruction reception portion 105 and the like).

In the above-described embodiment, when the display controller 101 allows the display portion 150 to display the detailed item setting window of the default window, the display portion 150 displays set values of items of other detailed item setting window (second window) which are changed from the default value in a separate display frame (FIG. 15). However, the plurality of items and their set values may be collectively displayed in one display frame.

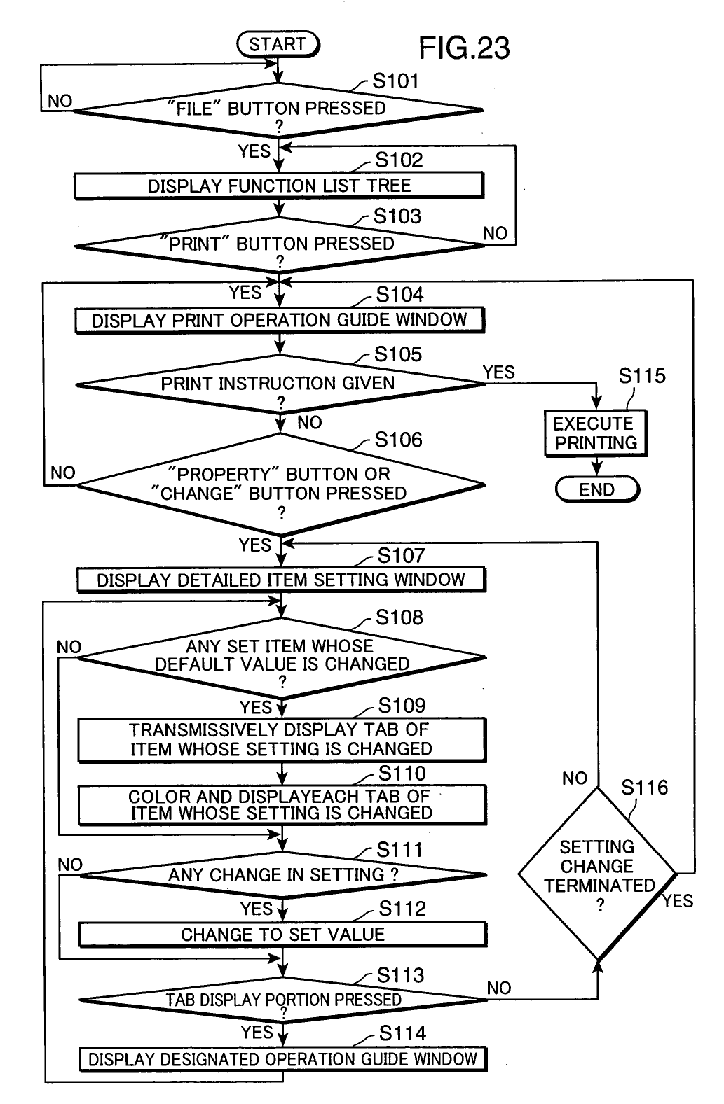

Next, a sixth embodiment of the display control executed at the time of printing by the PC 1 in which a display control program according to one embodiment of the present invention will be described. FIG. 23 is a flowchart showing a sixth embodiment of the display control executed by the PC 1 at the time of printing. An example of the detailed item setting window is as shown in FIG. 10.

In the sixth embodiment, the display controller 101, the setting change reception portion 102, the separate window display instruction reception portion 103, the cancel instruction reception portion 104, the instruction reception portion 105, the controller 106 and the output portion 107 of the CPU 100 functions similarly as that of the above-described fourth embodiment.

The sixth embodiment of the display control executed at the time of printing by the PC 1 in which the display control program according to one embodiment of the present invention will be described with reference to FIG. 23. FIGS. 24 though 31 show examples of window displays of the display portion 150. Further, descriptions of processing similar to those of the fourth and fifth embodiments will be omitted.

Similarly to the fourth and fifth embodiments, the display controller 101 determines at the time of allowing the display portion 150 to display the detailed item setting window H whether or not at least one of the items which cannot be set in the displayed detailed item setting window H but can be set in any one of the second windows (page layout (2in1 and the like), background printing, and the like) has been changed from the default value (initial set value) in previous operations (S108).

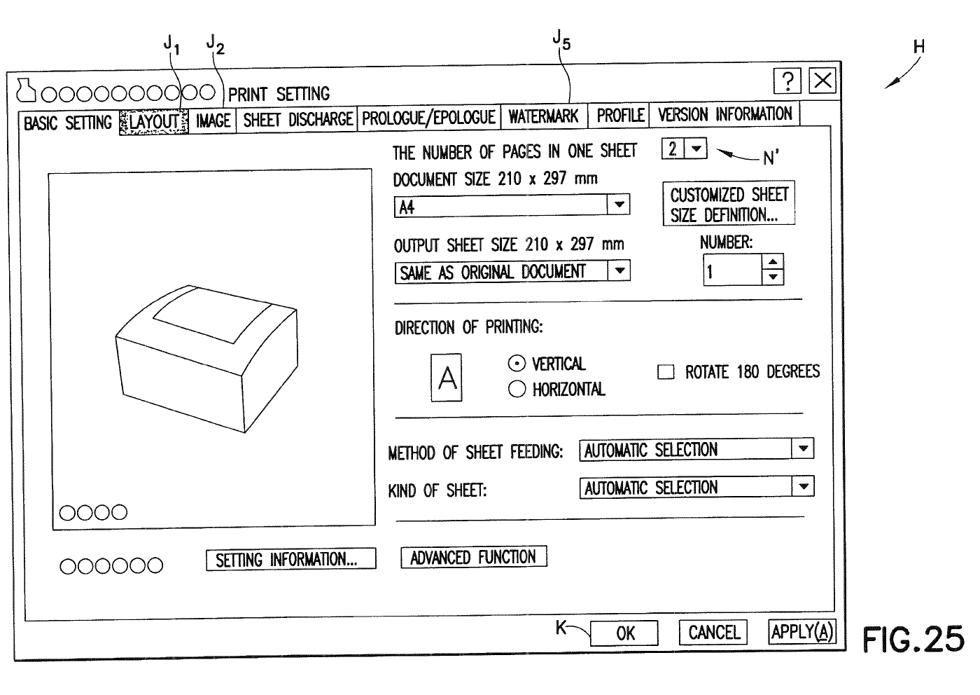

Here, when the display controller 101 determines that there is an item which is changed from the default value in any one of the second windows (YES in S108), the display controller 101 allows the display portion 150 to transmissively display in the default window the display part presenting the set value of the item whose default value is changed (S109). For example, when an operator operates a mouse to change the number of pages in one sheet from the default value of “1” to “2” in a setting space N of the item presenting the number of pages for one sheet in a layout second window M shown in FIG. 24, the display controller 101 allows the display portion 150 to transmissively display character portion and operation button portion in the setting space N of the item of the number of pages for one sheet in the detailed item setting window which is a default window (hereinafter, referred to as “default window H”) as shown in FIG. 25. In other words, the display controller 101 allows the display portion 150 to display character portion and operation button portion of a setting space N of the item for the number of pages in one sheet in the layout second window M, which are hidden in the case where the default window H is set to be the upper most layer, as a transmissive display part N′ in the default window H. Accordingly, the operator can see the character portion and operation button portion of the setting space N of the item for the number of pages in one sheet in the layout second window M transmissively through the default window H.

Further, the display controller 101 allows the display portion 150 to display a tab display part, which presents a detailed item setting window which is operable to change setting of a set value of an item whose default value is changed, in a display form different from the one before the set value is changed (S110). For example, the display controller 101 allows the display portion 150 to display the tab display part in a display form different from tab display parts corresponding to other second windows. As shown in FIG. 25, when the set value is changed from the default value in a setting space N of the item for the number of pages in one sheet in layout second window M, the display controller 101 displays a tab display part, which corresponds to the layout second window M being a second window operable to change setting of the setting space N for the item of the number of pages in one sheet, in the default window H in a color different from tab display parts corresponding to other second windows.

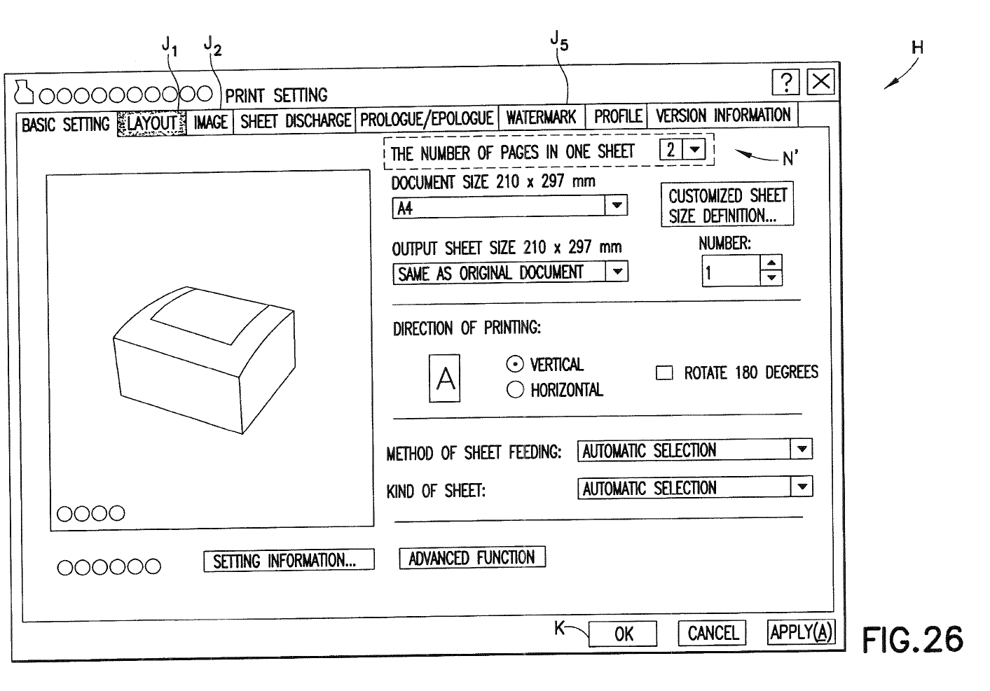

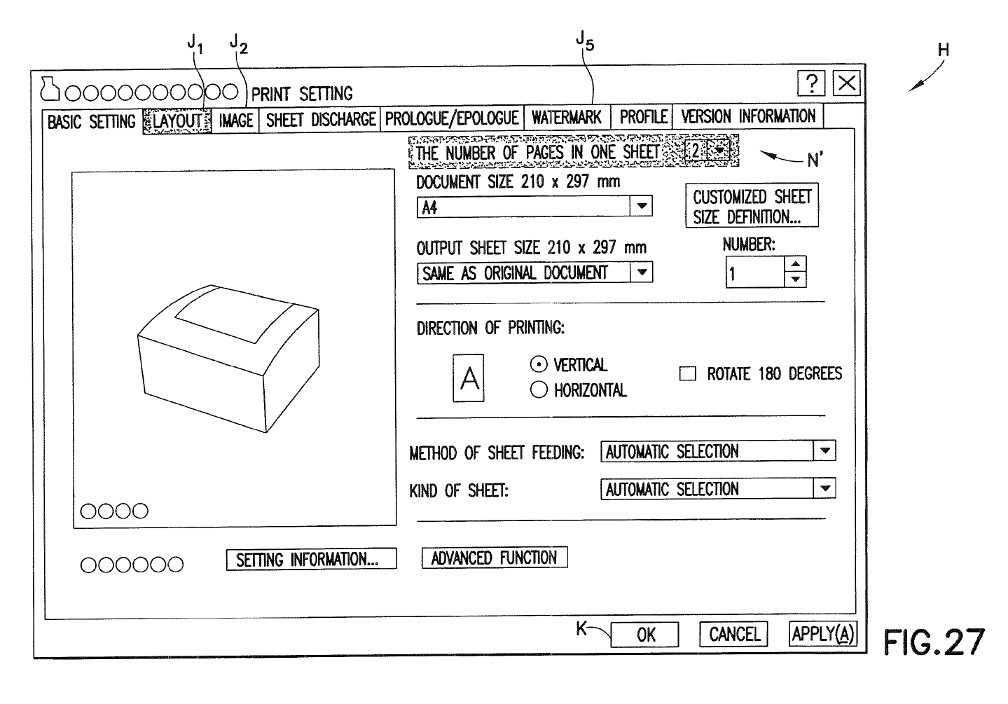

Other display form of the above-described transmissive display part N′ (the display part presenting a set value of an item whose default value is changed) in the default window H and a tab display part corresponding to a second window which is operable to change the set value of the item presented by the transmissive display part N′ will be described. For example, as shown in the following drawings, the display controller 101 may allow the display portion to display the transmissive display part N′ in the default window in a decorated display form. As shown in FIG. 26, the display controller 101 may allow the display portion 150 to display the transmissive display part N′ in the default window H in a decorated display form of surrounding the transmissive display part N′ with broken lines. The lines may be of other kinds such as solid lines and double lines (Hereinafter, these lines will be referred to as “broken lines or the like”.) so that the operator can easily recognize that the transmissive display part N′ presents a set value of an item which should originally be changed in a second display window. In such case, when a display part corresponding to a second window, which is operable to change the set value of an item displayed transmissively in the default window H, is displayed in a color different from tab display parts corresponding to other second windows, the display controller 101 may allow the display portion 150 to display the broken lines or the like in a color which is the same as that of a display color of the tab display part corresponding to the transmissive display. Further, as shown in FIG. 27, the display controller 101 may allow the display portion 150 to display an inner area of the transmissive display part N′ surrounded by the broken lines or the like and a corresponding tab display part in the same display color.

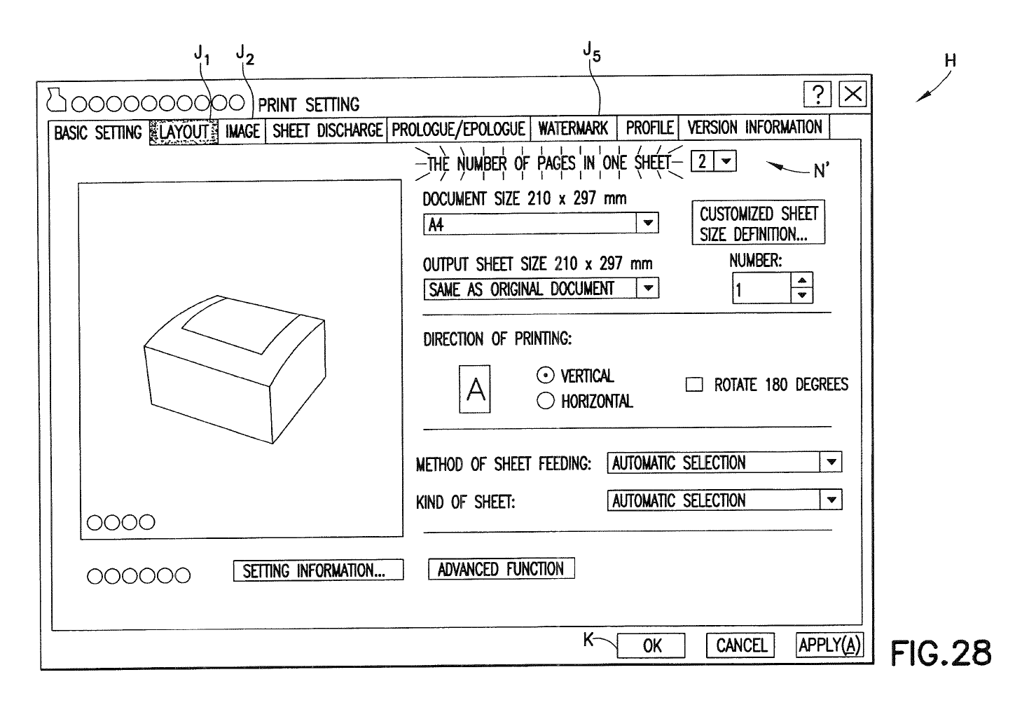

Further, as shown in FIG. 28, the display controller 101 may allow the display portion 150 to display the transmissive display part in the default window H in a blinking display. Further, in place of the blinking display, the display controller 101 may allow the display portion to display the transmissive display part in a highlighted form to make the transmissive display part be distinguished from other items displayed in the default window H.

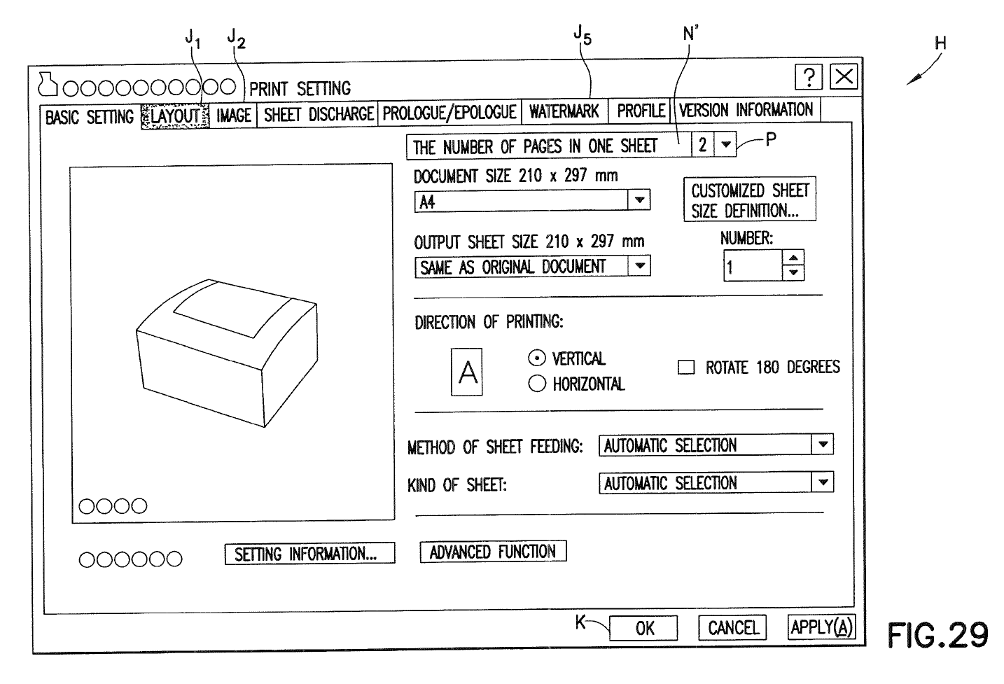

Further, as shown in FIG. 29, the display controller 101 may allow the display portion 150 to not only display the character portion and operation button portion of the transmissive display part N′ in the default window H but may directly extract the display part presenting a set value of the item changed from the default value and display the same in the default window H. In such case, since a background color of the transmissive display part N′ and a background color of the default window H are often designed to have the same color, the display controller 101 allows the display portion 150 to display an area P at a border between the transmissive display part N′ and the default window H in a color different from the background color.

According to these display controls, the operator can grasp a set value of an item whose default value is changed in the second window in a state where the default window H without making an operation to display a second window (for example, the layout second window M). Further, the operator can easily grasp a second window which is operable to change a set value of the item displayed transmissively in the default window H by visually confirming the tab display part displayed in a different color in the default window H. The display controller 101 may allow the display portion 150 to display a tab display part corresponding to a second window, which is operable to change a setting of an item whose default value is changed, in display forms such as a bold frame, a half-tone dot meshing, and enlargement so as to make the tab display part in a display form different from a tab display before the set change or other tab display parts.

When a plurality of items are changed from their default values, the display controller 101 allows the display portion 150 to display set values of items transmissively in the default window H and display a tab display part presenting a second window which is operable to change setting of set values of items which are transmissively displayed in the different display form.

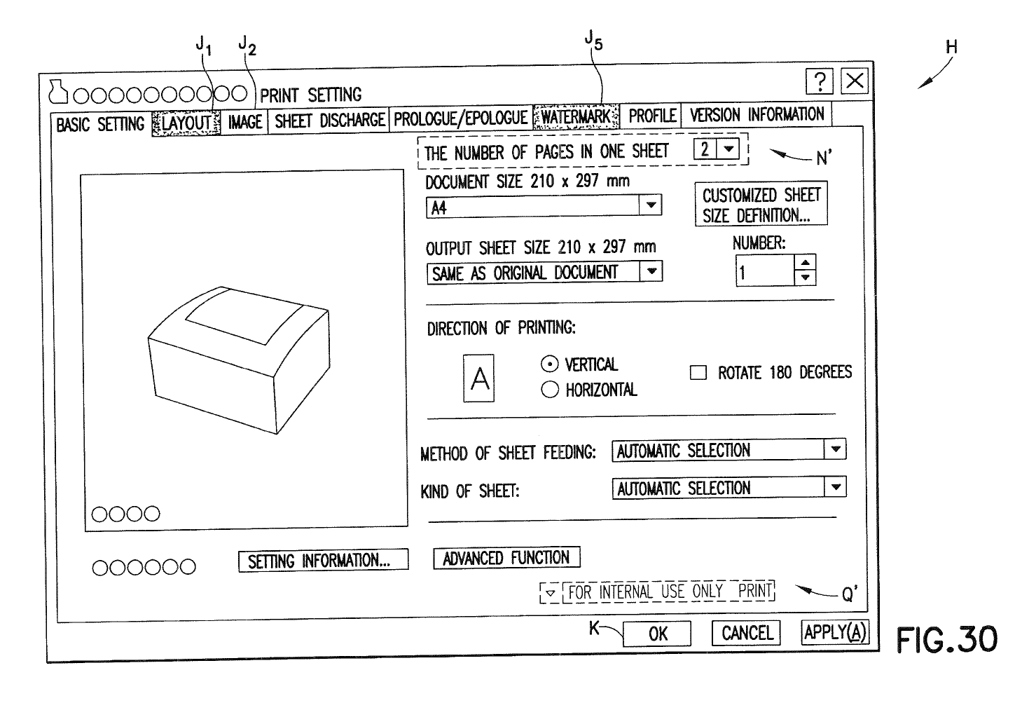

A display form in a case where the display controller 101 allows the display portion 150 to display set values of a plurality of items transmissively in the default window H will be described. When set values of a plurality of items are transmissively displayed in the default window H, the display controller 101 may allow the display portion 150 to display the set values of the plurality of items transmissively in the similar display form. Further, when the plurality of second windows respectively have designated hierarchical layers, the display controller 101 may also allow the display portion 150 to differ the display form of the transmissive display parts of the default window in accordance with differences in layers of the second windows. For example, when the display controller 101 allows the display portion 150 to display seven windows including a layout second window, an image second window, a sheet-discharging second window, a version information second window as second windows, the display controller 101 designates respective layers to the second windows so that the layout second window is designated as the first layer displayed as the uppermost window among the second windows, the image second window as the second layer displayed as the upper window after the layout second window, the sheet-discharging second window as the third layer displayed as an upper window after the image second window . . . and the version information second window as the seventh layer displayed as the lowermost window among the second windows. When set values of the items of the second windows are transmissively displayed in the default window, the display controller 101 allows the display portion 150 to display the set values in different darkness in accordance with difference in layers of the second windows by making it lighter as it goes from the uppermost window to the lowermost window. For example, as shown in FIG. 30, the display controller 101 allows the display portion 150 to display transmissive display part N′ presenting a set value of the layout second window at high darkness since it is the upper most layer window and display the transmissive display part Q′ presenting a set value of the item of the watermark second window at a density which is lower than that of the transmissive display part N′ since it is a layer window at a level lower than the layout second window. Such display control executed by the display controller 101 gives impression to an operator that a set value of an item of a window at a high hierarchical layer has high transmissivity and displayed clearly and that a set value of an item of a window at a low hierarchical layer has low transmissivity and displayed unclearly, and makes the operator feel that windows at lower hierarchical layer have low transmissivity.

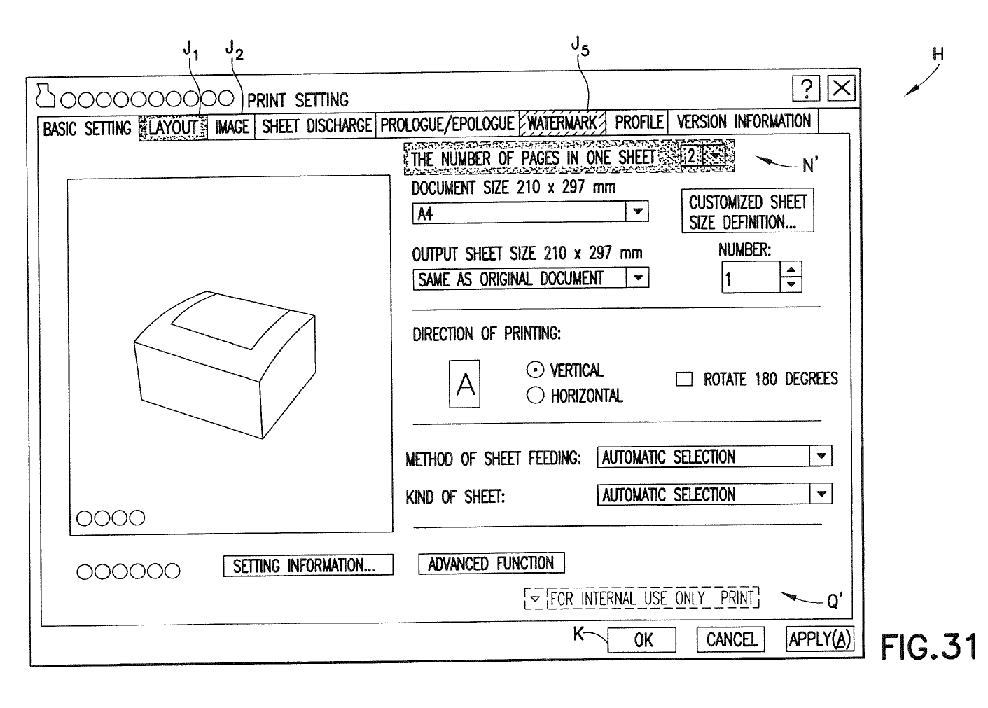

Further, as shown in FIG. 31, the display controller 101 may allow the display portion 150 to display inner parts of broken lines respectively surrounding a plurality of transmissive display parts or at least the broken line portions and the tab display parts respectively presenting the second windows corresponding to the transmissive display parts in the same color so as to indicate that which second window is operable to change settings of respective items of the plurality of transmissive display parts.

According to these display control, the operator can easily grasp which second window is operable to change a respective set value based on the transmissivity of each item displayed transmissively.

The display controller 101 skips processing of S109 and S110 when it determines that there is no item which is changed from the default value (NO in S1108).

Any one of the processing S107 and S108 may be executed ahead. In S108, the display controller 101 allows the display portion 150 to transmissively display a set value of an item which is changed from the default value in the default window H and displays the tab display part, which displays a second window being operable to change the set value, in a display form which is different from that of other tabs. Alternatively, in S108, the display controller 101 may determine whether or not there is an item whose set value is changed at the time of execution of the previous printing processing, transmissively display a set value of an item whose set value is changed, and then display the tab display part which displays a second window operable to change the set value being transmissively displayed in a display form different from that of other tabs.

Now it is referred back to description of FIG. 23. When the operator operates the mouse pointer to change setting of any one of the items, such as changing a sheet feeding method, at the time when the default window H is displayed and the setting change reception portion 102 receives a setting change instruction (YES in S111), the controller 106 changes the item, whose setting is changed, to a value in accordance with an instruction from the operator and stores the same (S112). This set change of an item in the default window H can be made regarding a plurality of items until the operator operates a mouse to click the OK button K (NO in S113, NO in S116, S107).

When the default window H is displayed and the operator operates the mouse to click OK button K (YES in S116), the routine goes back to S104 and the display controller 101 allows the display portion 150 to display the print operation guide window D again.

Further, when the operator operates the mouse to click any one of tabs (layout tab J1, image tab J2, . . . ) displayed in an upper portion of the default window H (YES in S113), the display controller 101 switches the display to other designated detailed item setting window (second window) (S114). Thereafter, the routine goes back to S108. Then, the display controller 101 continues execution of processing of S108 through S113 after the switching of the display to other detailed item setting window. In other words, even after the display is switched to other detailed item setting window, the display controller 101 allows the display portion 150 to transmissively display the set value, which is changed from the default value in a different detailed item setting window before the switching, in the detailed item setting window after the switching.

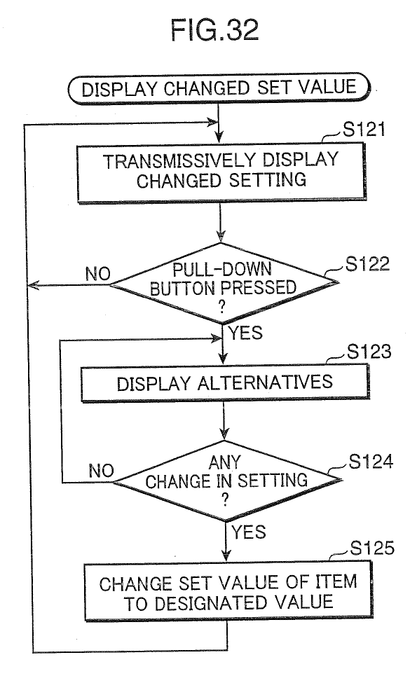

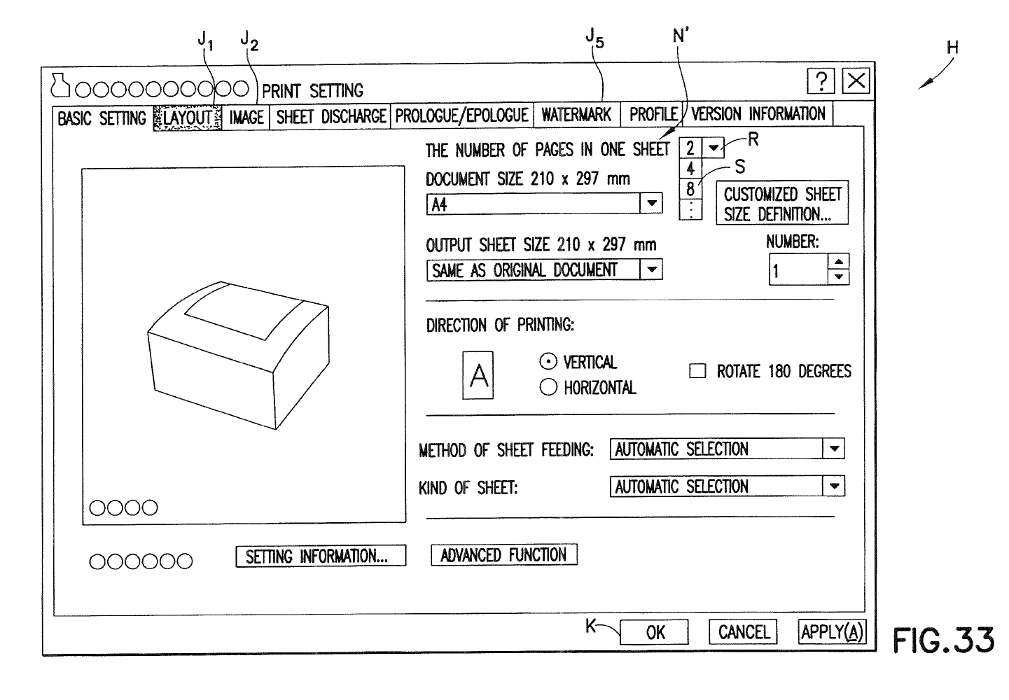

Next, a processing of changing a set value of an item transmissively displayed in the default window according to the sixth embodiment will be described. FIG. 32 is a flowchart showing a processing of changing a set value of an item transmissively displayed in the default window. FIG. 33 shows an example of a window display of the display portion 150.

According to the display control shown in FIG. 23, when an operator would like to change a set value of an item displayed transmissively in the default window H, the operator operates a mouse to click a tab display part displaying other second window corresponding to the set value and makes an operation of switching a display to the second window. Then, in the switched second window, the operator performs an operation of changing the set value which he would like to change. On the other hand, as will be described herebelow, the operator may operate with a mouse the above-described transmissive display part in the default window H so that he can change the transmissively displayed set value in a state where the default window is displayed.

When a set value of an item which is changed from the default value in the default window H is displayed as a transmissive display part N′ (S121), and the operator operates the mouse to click the pull-down button R transmissively displayed as an operation button as shown for example in FIG. 33, and the setting change reception portion 102 receives an instruction of displaying alternative values (YES in S122), the display controller 101 allows the display portion 150 to display a plurality of alternative values of the set value on the default window in a pull-down display S, for example (S123). Here, when the operator operates the mouse to click a part displaying a value to be newly set among the plurality of alternative values, and setting change reception portion 102 receives an instruction of changing the value given by the operator (YES in S124), the controller 106 changes the set value of the item to a designated value (S125).

Accordingly, the operator can change setting of a set value of an item which is transmissively displayed in the default window in a state where the default window is displayed by operating the pull-down button R without switching a display of a second window which is operable to change a set value of a transmissively displayed item. Accordingly, operability further improves.

The display controller 101 executes a display control of executing the above-described transmissive display in accordance with whether a default value of the item is changed or a set value of the item is changed at the time of executing a previous printing processing. Accordingly, the display controller 101 may allow the display portion 150 to display or hide the transmissive display when the set value of an item is changed to a default value or shifted to a state where a set value is not changed at the time of executing the previous printing processing.

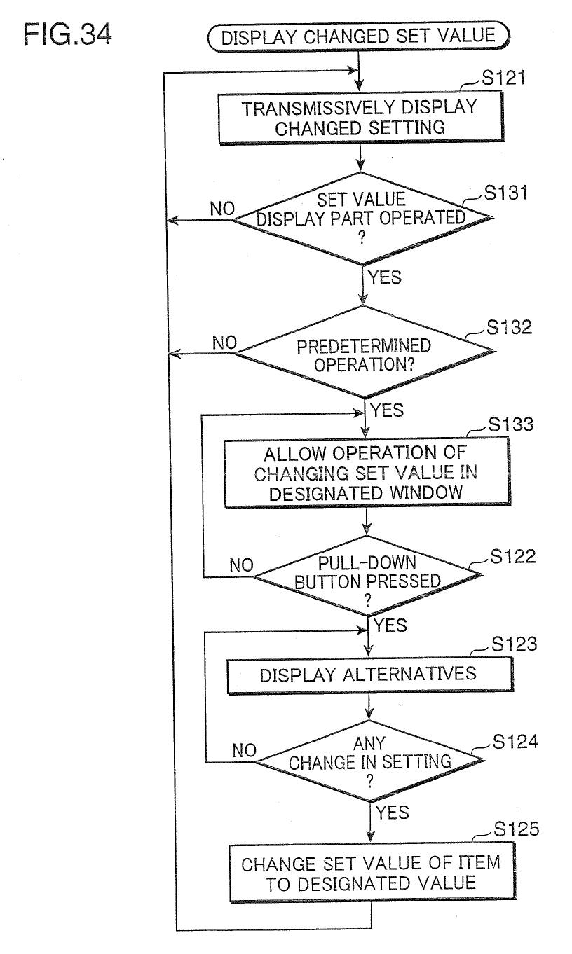

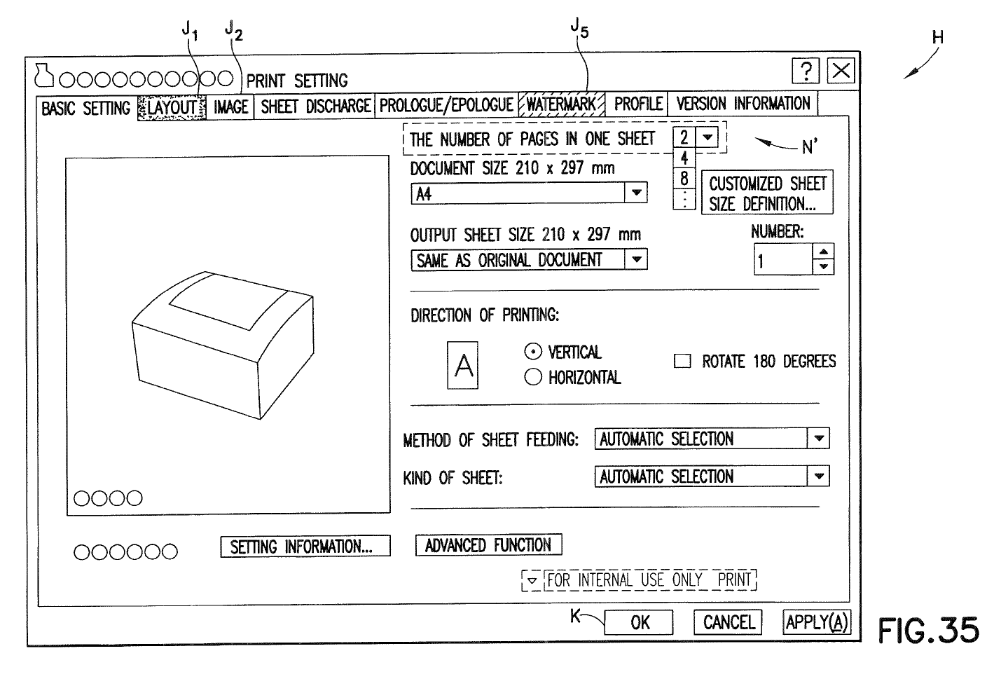

Further, other embodiment of processing of changing the set value in a case where set values of a plurality of items are transmissively displayed in the default window of the sixth embodiment will be described. FIG. 34 is a flowchart showing another embodiment of a processing of changing set values in a case where a plurality of items are transmissively displayed in the default window. FIG. 35 shows an example of a window display of the display portion 150. A processing which is similar to that shown in FIG. 32 is provided with the same reference signs and their descriptions will be omitted.

When the display controller 101 executes a plurality of the above-described transmissive display in the default window H and an operator performs a predetermined operation corresponding to a respective second window such as an operation of the pull-down button R with use of operation of a mouse, the setting change reception portion 102 may receive an instruction of changing the transmissively displayed set value of a second window corresponding to the operation. For example, with reference to FIGS. 34 and 35 for description, when the operator operates the mouse to move the mouse pointer to a desirable transmissive display part for changing a set value and the setting change reception portion 102 identifies the mouse operation (YES in S131), the setting change reception portion 102 determines whether or not the mouse operation performed by the operator matches with the predetermined operation corresponding to a second window which is operable to change a set value of an item of the transmissive display part designated with the mouse pointer (for example, one click for a second window in the uppermost level, two clicks for a second window in the next layer, and three clicks for a second window in the further next layer, when hierarchical layers are designated for the second windows respectively). When the mouse operation matches with the predetermined operation described above (YES in S132), the setting change reception portion 102 allows reception of operation of the pull-down button R of the transmissive display part designated by the mouse pointer in accordance with a mouse operation of the operator (S133).

Accordingly, since a set value which is transmissively displayed in the default window cannot be changed unless the operator performs a predetermined operation corresponding to a respective second window, the operator perform a changing operation while recognizing whether the set value is of which item of a second window at the time of changing the transmissively displayed set value. Consequently, it can be prevented that an operator changes a value of other second window by mistake.

A display device which performs the display control according to the sixth embodiment includes, for example, the display portion 150 and the CPU 100 (necessary functions among the display controller 101, the setting change reception portion 102, and the instruction reception portion 105).

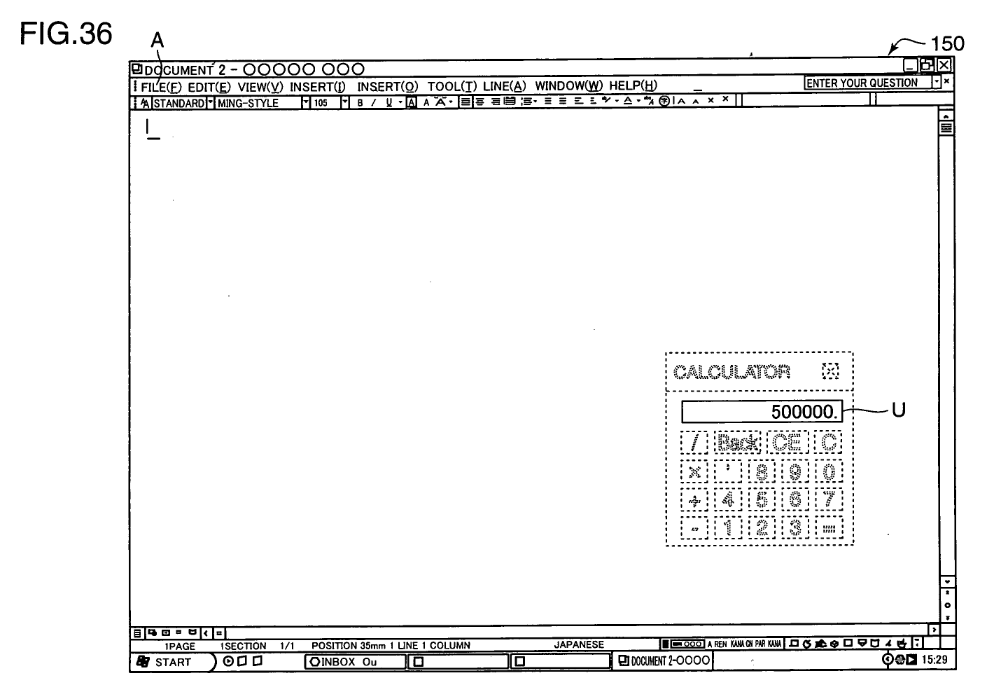

Further, in the above-described sixth embodiment, the display control program, the display device, and the display control method according to an embodiment of the present invention are described with use of an example of applying the same to the case where the display portion 150 selectively switches the default window H and a second window at the time of executing print setting in a word processing application. However, the display control program and the like as the sixth embodiment are not limited to this. For it can also be applied in a case where, for example, a plurality of applications run at the same time in the personal computer 1 and the display portion 150 selectively displays windows of the applications. For example, when a calculating application and a word processing application run at the same time in the personal computer 1, and the display controller 101 identifies that the display portion 150 displays a calculation result as a window for the calculating application, the display control program treats the window of the application of calculation as the second window and treats a value presenting the calculation result as a set value changed in the second window. Further, when the instruction reception portion 105 receives from the operator an instruction to display the window of the word processing application at a level higher than a level of the window of the calculating application, the display controller 101 allows the display portion 150 to display a window of the word processing application and display a value presenting the calculation result in a window of the calculating application as a transmissive display part U on the window of the application of the word processor, as shown in FIG. 36. In FIG. 36, parts other than a display part of the application of calculation are presented with broken lines. However, it is preferable that the parts in broken lines is hidden or displayed at a darkness which is lower than that of the transmissive display part U. Accordingly, after allowing the display portion 150 to display a window of the application of a word processor, the operator can grasp the calculation result of the application of calculation and easily perform operation such as inputting the calculation result to the application of a word processor without performing an operation of allowing the window of the application of calculation. In this case, the display control program may be incorporated in the above-described applications or may be installed to the personal computer 1 (HDD 200) separately from the above-described applications.

The present invention is not limited to configurations of the above-described first through sixth embodiments but may be modified in various ways. For example, the display device according to the first through sixth embodiments including the display portion 150 and the CPU 100 (necessary functions among the display controller 101, the setting change reception portion 102, the separate window display instruction reception portion 103, the cancel instruction reception portion 104, and the instruction reception portion 105) may be applied to an image forming apparatus having an image forming mechanism adopting methods such as an electrophotographic method and an ink-jet method. In such case, an operation panel such as an LCD (Liquid Crystal display portion) or the like provided in the image forming apparatus may serve as the display portion 150, and a central controller provided in the image forming apparatus for controlling overall operation of the image forming apparatus may serve as the CPU 100.

Further, it is described in the above-described first through sixth embodiments that the personal computer 1 functions in accordance with a display control program according to an embodiment of the present invention. However, the computer recited in claims is not limited to a personal computer but may include computer functions which are loaded in various electric appliances. For example, computer functions provided in various office automation equipments and home electric appliances (a microcomputer, an IC and the like would be enough if having a function to execute a program).

Furthermore, in the first through sixth embodiments, a display control program, a display device and a configuration and control of displaying method are described with reference to FIGS. 1 through 36. However, these are mere examples and have no effect of limiting the display control program, the display device and the configuration and control of displaying method to the above-described configurations and controls.

In general, the routines executed to implement the embodiment of the invention, whether implemented as part of an operating system or a specific application, component, program, object, module or sequence of instructions will be referred to as “programs”. The program comprises one or more instructions that are resident at various times in various memory and storage devices in a computer, and that cause the computer to perform the steps necessary to execute steps or elements embodying the various aspects of the invention.

The embodiments of the invention has and will be described in the context of functioning the computer and computer system. However, those skilled in the art will appreciate that various embodiments of the invention are capable of being distributed as a program product in a variety of forms, and that the invention applies equally regardless of the particular type of computer-readable media used to actually carry out the distribution. Examples of computer-readable media include but are not limited to recordable type media such as volatile and non-volatile memory devices, floppy and other removable disks, hard disk drives, optical disks (e.g., CD-ROM's, DVD's, etc.), among others, and transmission type media such as digital and analog communication links, including the Internet.

In short, the present invention includes a program product, comprising: a display control program for allowing a display portion to display an operation guide for an operator; and a computer-readable media storing the display control program. The display control program allows a computer to serve as: a display controller which allows the display portion to display an operation guide screen presenting to an operator that values of a plurality of items are changeable; and a set change reception portion which receives from the operator instructions of changing the set values of the items when the display controller allows the display portion to display the operation guide screen. The display controller allows a display form of a display part for a predetermined description to be different from other display area in the operation guide screen when the display controller allows the display portion to display the operation guide screen.

According to this invention, the display controller allows a display form of a display part for a predetermined description to be different from other display area in the operation guide screen when the display controller allows the display portion to display the operation guide screen. Accordingly, an operator can easily confirm setting of an operation regarding the predetermined description so that operability improves.

Further, according to the present invention, the display controller allows the display portion to display one or more items and its or their set values in display frames being separate from the operation guide screen and serving as the display part for the predetermined description when the display controller allows the display portion to display the operation guide screen.

According to this invention, the display portion displays the operation guide screen presenting to an operator that values of a plurality of items can be changed and one or more items and its or their set values in separate frames at the same time. Accordingly, the operator can easily confirm a set value of an item which is subjected to be displayed by visually confirming the separate display frame. Consequently, operability improves.

Further, in the present invention, the display controller allows the display portion to display in the separate display frame the item whose set value cannot be confirmed in the operation guide screen but can be changed only in a subordinate display screen which is allocated in a hierarchical layer at a level lower than that of the operation guide screen.

According to this invention, the display portion displays in the separate display frame the item whose set value can be changed only in a subordinate display screen which is allocated in a hierarchical layer at a level lower than that of the operation guide frame. Accordingly, the operator can confirm in the separate display frame the set value of the item which is set in the subordinate display screen without performing an operation to allow the display portion to display the subordinate display screen. Consequently, operability improves dramatically.

Further, in the present invention, the display controller allows the display portion to display items and their set values in a plurality of separate display frames corresponding to the respective items when the display controller allows the display portion to display a plurality of items and their set values.

According to this invention, the display portion displays the operation guide frame and items and their set values in the separate frames at the same time. Accordingly, it becomes further easier for the operator to confirm the items and their set values. Consequently, operability further improves.

Further, in the present invention, the display controller allows the display portion to display the item and its set value in the separate display frame when the value of the item is changed in accordance with the set change instruction received by the set change reception portion.

According to this invention, the display portion displays the item whose set value is changed by an operator and its changed value in a display frame which is separate from the operation guide frame. Accordingly, the operator can grasp the item having a value being different from the previous value and its set value more assuredly with the separate display frame.

Further, in the present invention, the display controller allows the display portion to display the item and its changed set value in the separate display frame when the value of the item is changed from a default value.

According to this invention, the display portion displays the item whose value is changed from the default value and its changed value in a display frame which is separate from the operation guide frame. Accordingly, the operator grasp the item having a value being different from the previous value and its set value more assuredly with the separate display frame.

Further, in the present invention, the display control program further allows the computer to serve as a separate display instruction reception portion which receives from the operator an instruction of allowing the display portion to display any of the items and their set values in the separate display frame, and the display controller allows the display portion to display the item and its set value in the separate display frame in accordance with the separate display instruction received by the separate display instruction reception portion.

According to this invention, the display portion displays the item and its set value in the separate display frame in accordance with the separate display instruction received by the separate display instruction reception portion. Accordingly, the operator can grasp a desirable item and its set value with the separate display frame more assuredly.

Further, in the present invention, the display control program further allows the computer to serve as a cancel instruction reception portion which receives from an operator a cancel instruction of cancelling the display of the separate display frame, and the display controller cancels the display of the separate display frame in accordance with the cancel instruction received by the cancel instruction reception portion.

According to this invention, the display of the set value in the separate display frame is cancelled in accordance with the cancel instruction given by the operator and received by the cancel instruction reception portion. Accordingly, the operator can hide a desirable set value displayed in the separate display frame.

Further, in the present invention, the display controller allows the display portion to display in the separate display frame a set change button which receives an instruction of changing the set value displayed in the display frame, and the set change reception portion receives the instruction of changing the set value displayed in the display frame in accordance with an operation of the set change button by an operator through an input device of a computer.

According to this invention, the operator can change the respective set value of the item displayed in the separate display frame by operating the setting change button displayed in the separate display frame. Accordingly, it becomes easy for the operator to change the set value of the item displayed in the display frame.

Further, in the present invention, the display controller allows the display portion to display a default screen which serves as an operation guide screen enabling an operator to change set values of one or more items, and a second screen which is operable to change the set value of one or more items and displayed when switched from the default screen. The set change reception portion receives from the operator an instruction of changing the set value of the item when the display controller allows the display portion to display the default screen or the second screen. The display controller further allows the display portion to display in the default screen the set value of the item which is changeable in the second screen as the display part of the predetermined description.

According to this invention, the display portion displays in the default screen the set value of the item which is changeable in the second screen as the display part of the predetermined description. Accordingly, the operator can confirm the set value of the item which is changeable in the second screen without performing an operation of displaying the second screen. Consequently, operability improves.

Further, in the present invention, the display controller allows the display portion to display separately in the default screen the set values of the items which are changeable in the second screen when the display controller allows the display portion to display a plurality of items and their set values.

According to this invention, the display portion displays separately in the default screen the set value of the item which is changeable in the second screen when the display controller allows the display portion to display a plurality of items and their set values. Accordingly, it becomes easier for the operator to confirm set values of the items which are changeable in the second screen. Consequently, operability further improves.

Further, in the present invention, the display controller allows the display portion to display a changed set value in the default screen when a value of at least one of the items which are changeable in the second screen is changed in accordance with the set change instruction received by the set change reception portion.

According to this invention, when a value of at least one of the items which are changeable in the second screen is changed, the changed set value is displayed in the default screen. Accordingly, the operator can grasp the item having a value different from the previous one and its set value more assuredly with the display.

Further, in the present invention, the display controller allows the display portion to display a changed set value in the default screen when a set value of at least one of the items which are changeable in the second screen is changed from a default value in accordance with the set change instruction received by the set change reception portion.

According to this invention, when a set value of at least one of the items which are changeable in the second screen is changed from a default value, a changed set value is displayed in the default screen. Accordingly, the operator can grasp the item having a value which is different from the previous one and its set value more assuredly with the display.

Further, in the present invention, the display controller allows the display portion to display a set change button which receives an instruction of changing the set value at a display part of the default screen presenting the set value which is changeable in the second screen, and the set change reception portion receives the instruction of changing the set value in accordance with an operation of the set change button by an operator through an input device of a computer.

According to this invention, the operator can change the set value of the item which should be changed in the second screen by operating the setting change button without performing an operation of displaying the second screen. Accordingly, it becomes easier to change the set value of the item which should be changed in the second screen.

Further, in the present invention, the display controller allows the display portion to display the guide display and a set value of the changed item alternately at a predetermined interval at a part of the default screen presenting a switching guide of switching to the second screen which is operable to set a changed item when a value of at least one of the items which are changeable in the second screen is changed in accordance with a set change instruction received by the set change reception portion.

According to this invention, the display portion displays the guide display and a set value of the changed item alternately at an interval at a part of the default screen presenting a guide to the second screen which is operable to set the changed item. Accordingly, the changed set value is displayed within the part of the default screen presenting a guide to the default screen. Therefore, even if the amount of information displayed in the default screen increases, it does not give an operator an impression that contents of display in the default screen is complicated, and the operator can confirm a set value of the item which is changeable in the second screen without performing an operation of displaying the second screen. Consequently, operability improves.

Further, in the present invention, the display controller allows the display portion to display the guide display and the a set value of the changed item with a scrolling display at a part of the default screen presenting a switching guide of switching to the second screen which is operable to set a changed item when a value of at least one of the items which are changeable in the second screen is changed in accordance with the set change instruction received by the set change reception portion.

According to this invention, the display portion displays the guide display and a set value of the changed item in a scrolling at a part of the default screen presenting a switching guide to the second screen which is operable to set the changed item. Accordingly, the changed set value is displayed within the part of the default screen presenting a guide to the se default screen. Therefore, even if the amount of information displayed in the default screen increases, it does not give an operator an impression that contents of display in the default screen is complicated, and the operator can confirm a set value of the item which is changeable in the second screen without performing an operation of displaying the second screen. Consequently, operability improves.

Further, in the present invention, the display controller allows the display portion to fixedly display at least one of the items to be displayed at a display part presenting a switching guide to the second screen allowing setting of the item changed in the default screen at the display part and display the item other than the fixedly displayed item in a scrolling display when a value of at least one of the items changeable in the second screen is changed in accordance with the set change instruction received in the set change reception portion.

According to this invention, the display portion fixedly displays at least one of the items to be displayed at a display part presenting a switching guide to the second screen allowing setting of the item changed in the default screen at the display part and displays the item other than the fixedly displayed item in a scrolling display. Accordingly, the changed set value is displayed within the part of the default screen presenting a guide to the default screen. Therefore, even if the amount of information displayed in the default screen increases, it does not give an operator an impression that contents of display in the default screen is complicated, and the operator can confirm a set value of the item which is changeable in the second screen without performing an operation of displaying the second screen. Consequently, operability improves.

Further, in the present invention, the display controller allows the display portion to display a default screen which serves as an operation guide screen enabling the operator to change the set value of one or more items, and a second screen which is operable to change a set value of one or more items and displayed when switched from the default screen, the set change reception portion receives from the operator an instruction of changing a set value of an item when the display controller allows the display portion to display the default screen or the second screen, and the display controller further allows the display portion to display the display part showing the second screen enabling setting of the changed item in the default screen in a manner different from the previous display when a value of at least one of the items which are changeable in the second screen is changed in accordance with the set change instruction received by the set change reception portion.

According to this invention, when a value of at least one of the items which are changeable in the second screen is changed, the display portion displays the display part in the default screen showing the item whose set value is changed in a different from the previous display. Accordingly, the operator can confirm that a set value of the item which is changeable in the separate second screen without operation of displaying the second screen. Consequently, operability improves.

Further, in the present invention the display controller allows the display portion to display a default screen which serves as an operation guide screen enabling the operator to change the set value of one or more items, and the second screen which is operable to change a set value of one or more items and displayed when switched from the default screen. The set change reception portion receives from the operator an instruction of changing a set value of an item when the display controller allows the display portion to display the default screen or the second screen. The display controller further allows the display portion to display a display part of a set value changed in the second screen transmissively in the default screen when a set value of at least one of the items changeable in the second screen is changed in accordance with a set change instruction received in the set change reception portion.

According to this invention, when a value of at least one of the items which are changeable in the second screen is changed, the display controller allows the display portion to transmissively display the display part whose set value is changed in the default screen. Accordingly, the operator can confirm the set value of the item which should be changed in the second screen in a state where the default screen is displayed without performing an operation of displaying the second screen. Accordingly, operability improves.

Further, in the present invention, the display controller allows the display portion to display a display part of a set value changed in the second screen transmissively on the default screen when a set value of at least one of the items which are changeable in the second screen is changed from the default value in accordance with a set change instruction received in the set change reception portion.

According to this invention, when the item which can be changed in the second screen is changed from the default value, the display controller allows the display portion to display the changed set value in the default screen. Accordingly, the operator can grasp the item having a value different from the default value and its set value more assuredly with the display.

Further, in the present invention, the display controller allows the display portion to display the transmissive display part in the default screen in a decorated form.

According to this invention, the operator can easily understand that the transmissive display part shows a set value of an item which should be changed in the second display screen.

Further, in the present invention, the display controller allows the display portion to display a switching guide part of the default screen showing a switching guide to the second screen enabling changing of setting of a changed item in a display form which is different from the display form displayed prior to a changing of the set value when a set value of at least one of items which are changeable in the second screen is changed in accordance with a set change instruction received from the operator in the set change reception portion.

According to this invention, when a set value of at least one of items which are changeable in the second screen is changed, the display controller allows the display portion to display the part of the switching guide to the second screen which is operable to set the changed item in a display form displayed prior to a changing of the set value. Accordingly, the operator can easily grasp a second screen whose transmissively displayed set value is changeable among a plurality of second screens.

Further, in the present invention, the display controller provides a plurality of second screens which are switched from the default screen and allows the display portion to display the transmissive display part of the default screen in a display form which is the same as that of a switching guide portion of displaying a switching guide to the second screen enabling a changing of setting of the transmissively displayed item.

According to this invention, the operator can adequately grasp among a plurality of second screens which of the second screens enabling a changing of set value corresponds to any one of a plurality of transmissively displayed set value.

Further, in the present invention, the display controller prepares a plurality of second screens capable of being switched from the default screen and having hierarchical layers provided respectively, and makes a display form of the transmissive display part of the default screen be different in accordance with a difference in a hierarchical layer of a respective second screen.

According to this invention, the display controller makes a display form of the transmissive display part of the default screen be different in accordance with a difference in a hierarchical layer of a respective second screen. Accordingly, the operator can easily grasp which hierarchical layer among second screens is operable to change the transmissively displayed set value.

Further, in the present invention, the display controller allows the display portion to display a display part of a set value changed in the second screen and a set change button for receiving from the operator a set changing instruction about the set value transmissively on the default screen when a set value of at least one of the items which are changeable in the second screen is changed in accordance with a set change instruction received by the set change reception portion, and the set change reception portion receives a changing instruction of the set value based on an operator's operation of the set change button transmissively displayed in the default screen through an input device of the computer.

According to this invention, the operator can change a set value of an item which should be changed in a second screen by operating the setting change button displayed in the default screen without performing an operation of displaying the second screen.

Further, in the present invention, the display controller allows the display portion to display a display part of a set value changed in the second screen and a set change button for receiving from the operator a set changing instruction about the set value transmissively on the default screen when a set value of at least one of the items which are changeable in the second screen is changed in accordance with a set change instruction received by the set change reception portion, and when the display controller allows the display portion to transmissively display respective items of second screens in the default screen, and the operator operates the set change button through an input device of the computer to perform any of predetermined operations respectively corresponding to items in the second screens, the set change reception portion receives a changing instruction of a set value corresponding to an item in the second screen and transmissively displayed.

According to this invention, if the operator does not perform a predetermined operation corresponding to the second screen by using an input device of the computer, the operator cannot change the transmissively displayed set value of the corresponding second screen. Accordingly, the operator can perform a changing operation while recognizing which item of the second screen correspond to the set value at the time of changing the transmissively displayed set value. Consequently, it can be prevented that the operator changes a set value of other second screen by mistake.

Further, in the present invention, the display controller allows the display portion to display a default screen which serves as an operation guide screen enabling the operator to change a set value of one or more items, and a second screen which is operable to change a set value of one or more items and displayed when switched from the default screen. The set change reception portion receives from the operator an instruction of changing a set value of an item when the display controller makes the display portion display the default screen or the second screen. The display controller allows the display portion preferentially display a display part of the set value changed in the second screen at a part partially cut out from the default screen when a set value of any of the items changeable in the second screen based on a set change instruction received by the set change reception portion.

According to this invention, when any one of the set values of the items which are changeable in the second screen is changed, the display controller allows the display portion to preferentially display a display part of the set value changed in the second screen at a part partially cut out from the default screen. Accordingly, the operator can confirm the set value of the item which should be changed in the second screen in a state where the default screen is displayed without performing an operation of displaying the second screen. Accordingly, operability improves.

Further, in the present invention, the display controller allows the display portion to display in the display portion a first application screen as an operation guide screen which is operable to change a set value of one or more items through an operation by an operator and a second application screen which is operable to change a set value of one or more items in accordance with an operator's operation and displayed in accordance with a switching from the first application screen. The set change reception portion receives from an operator an instruction of changing a set value of an item when the display controller makes the display portion display the first or second application screen on the display portion. The display controller further allows the display portion to display a display part of the set value changed in the second application screen transmissively in the first application screen when a set value of any of the items changeable in the second application screen is changed in accordance with the set change instruction received by the set change reception portion.

According to this invention, when a set value of any one of the items changeable in the second application screen is changed, the display controller allows the display portion to display a display part of the set value changed in the second application screen transmissively in the first application. Accordingly, the operator can easily confirm a set value of an item which should be changed in the second application screen in a state where the first application screen is displayed without performing an operation of displaying the second application screen.

Further, the present invention includes a display device comprising: a display portion which displays an operation guide for an operator; a display controller which allows the display portion display an operation guide screen presenting to an operator that values of a plurality of items are changeable; and a set change reception portion which receives from the operator instructions of changing values of the items when the display controller makes the display portion display the operation guide screen. The display controller allows a display form of a display part for a predetermined description be different from other display area in the operation guide screen when the display controller allows the display portion to display the operation guide screen on the display portion.

Further, the present invention includes a display device in which the display controller allows the display portion to display one or more items and its or their set values in display frames being separate from the operation guide screen and serving as the display part for the predetermined description when the display controller allows the display portion to display the operation guide screen.

Further, the present invention includes a display device in which the display controller allows the display portion to display a default screen which serves as an operation guide screen enabling an operator to change set values of one or more items, and a second screen which is operable to change the set value of one or more items and displayed when switched from the default screen, the set change reception portion receives from the operator an instruction of changing the set value of the item when the display controller allows the display portion to display the default screen or the second screen, and the display controller further allows the display portion to display in the default screen the set value of the item which is changeable in the second screen as the display part of the predetermined description.

Further, the present invention includes a display device in which the display controller allows the display portion to display a default screen which serves as an operation guide screen enabling the operator to change the set value of one or more items, and the second screen which is operable to change a set value of one or more items and displayed when switched from the default screen, the set change reception portion receives from the operator an instruction of changing a set value of an item when the display controller allows the display portion to display the default screen or the second screen, and the display controller further allows the display portion to display a display part of a set value changed in the second screen transmissively in the default screen when a set value of at least one of the items changeable in the second screen is changed in accordance with a set change instruction received in the set change reception portion.

Further, the present invention includes a display control method for making the display portion display an operation guide for an operator. The method comprises the steps of: (1) allowing the display portion to display an operation guide screen presenting to an operator that values of a plurality of items are changeable; and (2) allowing the display portion to display a display part for a predetermined description to be in a display form which is different from other display area in the operation guide screen when a predetermined requirement is met.

Further, the present invention includes the display control method wherein, in step (2), the display portion is allowed to display the plurality of items and their set values in display frames being separate from the operation guide screen when the predetermined requirement is met.

Further, the present invention includes the display control method wherein, in step (1), the display portion displays a default screen which serves as an operation guide screen enabling an operator to change set values of one or more items, and a second screen which is operable to change the set value of one or more items and displayed when switched from the default screen are displayed, and in step (2), the display portion displays the set value of the item which is changeable in the default screen when the display portion displays the default screen or the second screen in step (1) and receives from the operator an instruction of changing the set value of the item.

Further, the present invention includes the display control method, wherein in step (1), the display portion displays a default screen which serves as an operation guide screen enabling an operator to change set values of one or more items, and a second screen which is operable to change the set value of one or more items and displayed when switched from the default screen are displayed, and in step (2), the display portion receives from the operator an instruction of changing a set value of an item when the display portion displays in step (1) the default screen or the second screen; and the display portion displays a display part of a set value changed in the second screen transmissively in the default screen when a set value of at least one of the items changeable in the second screen is changed in accordance with a set change instruction received in the set change reception portion.

Further, the present invention includes an image forming apparatus comprising: an image forming portion which performs a sequence of image forming operation to a recording sheet; a display portion which displays an operation guide regarding the image forming operation; a display controller which allows the display portion to display an operation guide screen presenting to an operator that values of a plurality of items are changeable; a set change reception portion which receives from the operator instructions of changing values of the items when the display controller allows the display portion to display the operation guide frame. The display controller allows a display form of a display part for a predetermined description to be different from other display area in the operation guide screen when the display controller allows the display portion to display the operation guide screen.

Further, the present invention includes the image forming apparatus, wherein the display controller allows the display portion to display one or more items and its or their set values in a display frame which is separate from the operation guide screen when the display controller allows the display portion to display the operation guide screen.

Further, the present invention includes the image forming apparatus, wherein the display controller allows the display portion to display a default screen which serves as an operation guide screen enabling an operator to change set values of one or more items, and a second screen which is operable to change the set value of one or more items and displayed when switched from the default screen, the set change reception portion receives from the operator an instruction of changing the set value of the item when the display controller allows the display portion to display the default screen or the second screen, and the display controller further allows the display portion to display in the default screen the set value of the item which is changeable in the second screen as the display part of the predetermined description.

Further, the present invention includes the image forming apparatus, wherein the display controller allows the display portion to display a default screen which serves as an operation guide screen enabling the operator to change the set value of one or more items, and the second screen which is operable to change a set value of one or more items and displayed when switched from the default screen, the set change reception portion receives from the operator an instruction of changing a set value of an item when the display controller allows the display portion to display the default screen or the second screen, and the display controller further allows the display portion to display a display part of a set value changed in the second screen transmissively in the default screen when a set value of at least one of the items changeable in the second screen is changed in accordance with a set change instruction received in the set change reception portion.

This application is based on Japanese Patent application serial Nos. 2006-216825, 2006-220399, and 2006-262781 filed in Japan Patent Office respectively on Aug. 9, 2006, Aug. 11, 2006, and Sep. 27, 2006 the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A program product, comprising:
a display control program for allowing a display portion to display an operation guide for an operator; and
a computer-readable media storing the display control program, wherein
the display control program allows a computer to serve as:
a display controller which allows the display portion to display an operation guide screen presenting to an operator that values of a plurality of items are changeable; and
a set change reception portion which receives from the operator instructions of changing the set values of the items when the display controller allows the display portion to display the operation guide screen, and
the display controller allows a display form of a display part for a predetermined description to be different from other display area in the operation guide screen when the display controller allows the display portion to display the operation guide screen.

2. The program product according to claim 1, wherein the display controller allows the display portion to display one or more items and its or their set values in display frames being separate from the operation guide screen and serving as the display part for the predetermined description when the display controller allows the display portion to display the operation guide screen.

3. The program product according to claim 2, wherein the display controller allows the display portion to display in the separate display frame the item whose set value cannot be confirmed in the operation guide screen but can be changed only in a subordinate display screen which is allocated in a hierarchical layer at a level lower than that of the operation guide screen.

4. The program product according to claim 2, wherein the display controller allows the display portion to display items and their set values in a plurality of separate display frames corresponding to the respective items when the display controller allows the display portion to display a plurality of items and their set values.

5. The program product according to claim 4, wherein the display controller allows the display portion to display the item and its set value in the separate display frame when the value of the item is changed in accordance with the set change instruction received by the set change reception portion.

6. The program product according to claim 4, wherein the display controller allows the display portion to display the item and its changed set value in the separate display frame when the value of the item is changed from a default value.

7. The program product according to claim 4, wherein:
the display control program further allows the computer to serve as a separate display instruction reception portion which receives from the operator an instruction of allowing the display portion to display any of the items and their set values in the separate display frame, and
the display controller allows the display portion to display the item and its set value in the separate display frame in accordance with the separate display instruction received by the separate display instruction reception portion.

8. The program product according to claim 2, wherein:
the display control program further allows the computer to serve as a cancel instruction reception portion which receives from an operator a cancel instruction of cancelling the display of the separate display frame, and
the display controller cancels the display of the separate display frame in accordance with the cancel instruction received by the cancel instruction reception portion.

9. The program product according to claim 2, wherein:
the display controller allows the display portion to display in the separate display frame a set change button which receives an instruction of changing the set value displayed in the display frame, and
the set change reception portion receives the instruction of changing the set value displayed in the display frame in accordance with an operation of the set change button by an operator through an input device of a computer.

10. The program product according to claim 1, wherein:
the display controller allows the display portion to display a default screen which serves as an operation guide screen enabling an operator to change set values of one or more items, and a second screen which is operable to change the set value of one or more items and displayed when switched from the default screen,
the set change reception portion receives from the operator an instruction of changing the set value of the item when the display controller allows the display portion to display the default screen or the second screen, and
the display controller further allows the display portion to display in the default screen the set value of the item which is changeable in the second screen as the display part of the predetermined description.

11. The program product according to claim 10, wherein the display controller allows the display portion to display separately in the default screen the set values of the items which are changeable in the second screen when the display controller allows the display portion to display a plurality of items and their set values.

12. The program product according to claim 10, wherein the display controller allows the display portion to display a changed set value in the default screen when a value of at least one of the items which are changeable in the second screen is changed in accordance with the set change instruction received by the set change reception portion.

13. The program product according to claim 10, wherein the display controller allows the display portion to display a changed set value in the default screen when a set value of at least one of the items which are changeable in the second screen is changed from the default value in accordance with the set change instruction received by the set change reception portion.

14. The program product according to claim 10, wherein:
the display controller allows the display portion to display a set change button which receives an instruction of changing the set value at a display part of the default screen presenting the set value which is changeable in the second screen, and
the set change reception portion receives the instruction of changing the set value in accordance with an operation of the set change button by an operator through an input device of a computer.

15. The program product according to claim 10, wherein the display controller allows the display portion to display the guide display and a set value of the changed item alternately at a predetermined interval at a part of the default screen presenting a switching guide of switching to the second screen which is operable to set the changed item when a value of at least one of the items which are changeable in the second screen is changed in accordance with a set change instruction received by the set change reception portion.

16. The program product according to claim 10, wherein the display controller allows the display portion to display the guide display and the a set value of the changed item with a scrolling display at a part of the default screen presenting a switching guide of switching to the second screen which is operable to set the changed item when a value of at least one of the items which are changeable in the second screen is changed in accordance with the set change instruction received by the set change reception portion.

17. The program product according to claim 10, wherein the display controller allows the display portion to display fixedly at least one of the items to be displayed at a display part presenting a switching guide to the second screen allowing setting of the changed item in the default screen at the display part and display the item other than the fixedly displayed item in a scrolling display when a value of at least one of the items changeable in the second screen is changed in accordance with the set change instruction received in the set change reception portion.

18. The program product according to claim 1, wherein:
the display controller allows the display portion to display a default screen which serves as an operation guide screen enabling the operator to change the set value of one or more items, and a second screen which is operable to change a set value of one or more items and displayed when switched from the default screen,
the set change reception portion receives from the operator an instruction of changing a set value of an item when the display controller allows the display portion to display the default screen or the second screen, and
the display controller further allows the display portion to display the display part showing the second screen enabling setting of the changed item in the default screen in a manner different from the previous display when a value of at least one of the items which are changeable in the second screen is changed in accordance with the set change instruction received by the set change reception portion.

19. The program product according to claim 1, wherein:
the display controller allows the display portion to display a default screen which serves as an operation guide screen enabling the operator to change the set value of one or more items, and the second screen which is operable to change a set value of one or more items and displayed when switched from the default screen,
the set change reception portion receives from the operator an instruction of changing a set value of an item when the display controller allows the display portion to display the default screen or the second screen, and
the display controller further allows the display portion to display a display part of a set value changed in the second screen transmissively in the default screen when a set value of at least one of the items changeable in the second screen is changed in accordance with a set change instruction received in the set change reception portion.

20. The program product according to claim 19, wherein the display controller allows the display portion to display a display part of a set value changed in the second screen transmissively on the default screen when a set value of at least one of the items which are changeable in the second screen is changed from the default value in accordance with a set change instruction received in the set change reception portion.

21. The program product according to claim 19, wherein the display controller allows the display portion to display the transmissive display part in the default screen in a decorated form.

22. The program product according to claim 19, wherein the display controller allows the display portion to display a switching guide part of the default screen showing a switching guide to the second screen enabling changing of setting of a changed item in a display form which is different from the display form displayed prior to a changing of the set value when a set value of at least one of items which are changeable in the second screen is changed in accordance with a set change instruction received from the operator in the set change reception portion.

23. The program product according to claim 22, wherein the display controller provides a plurality of second screens which are switched from the default screen and allows the display portion to display the transmissive display part of the default screen in a display form which is the same as that of a switching guide portion of displaying a switching guide to the second screen enabling a changing of setting of the transmissively displayed item.

24. The program product according to claim 19, wherein the display controller prepares a plurality of second screens capable of being switched from the default screen and having hierarchical layers provided respectively, and makes a display form of the transmissive display part of the default screen be different in accordance with a difference in a hierarchical layer of a respective second screen.

25. The program product according to claim 19, wherein:
the display controller allows the display portion to display a display part of a set value changed in the second screen and a set change button for receiving from the operator a set changing instruction about the set value transmissively on the default screen when a set value of at least one of the items which are changeable in the second screen is changed in accordance with a set change instruction received by the set change reception portion, and
the set change reception portion receives a changing instruction of the set value based on an operator's operation of the set change button transmissively displayed in the default screen through an input device of the computer.

26. The program product according to claim 23, wherein:
the display controller allows the display portion to display a display part of a set value changed in the second screen and a set change button for receiving from the operator a set changing instruction about the set value transmissively on the default screen when a set value of at least one of the items which are changeable in the second screen is changed in accordance with a set change instruction received by the set change reception portion, and
when the display controller allows the display portion to transmissively display respective items of second screens in the default screen, and the operator operates the set change button through an input device of the computer to perform any of predetermined operations respectively corresponding to items in the second screens, the set change reception portion receives a changing instruction of a set value corresponding to an item in the second screen and transmissively displayed.

27. The program product according to claim 1, wherein:
the display controller allows the display portion to display a default screen which serves as an operation guide screen enabling the operator to change a set value of one or more items, and a second screen which is operable to change a set value of one or more items and displayed when switched from the default screen,
the set change reception portion receives from the operator an instruction of changing a set value of an item when the display controller makes the display portion display the default screen or the second screen, and
the display controller allows the display portion preferentially display a display part of the set value changed in the second screen at a part partially cut out from the default screen when a set value of any of the items changeable in the second screen based on a set change instruction received by the set change reception portion.

28. The program product according to claim 1, wherein:
the display controller allows the display portion to display in the display portion a first application screen as an operation guide screen which is operable to change a set value of one or more items through an operation by an operator and a second application screen which is operable to change a set value of one or more items in accordance with an operator's operation and displayed in accordance with a switching from the first application screen,
the set change reception portion receives from an operator an instruction of changing a set value of an item when the display controller makes the display portion display the first or second application screen on the display portion, and
the display controller further allows the display portion to display a display part of the set value changed in the second application screen transmissively in the first application screen when a set value of any one of the items changeable in the second application screen is changed in accordance with the set change instruction received by the set change reception portion.

29. A display device, comprising:
a display portion which displays an operation guide for an operator;
a display controller which allows the display portion display an operation guide screen presenting to an operator that values of a plurality of items are changeable; and
a set change reception portion which receives from the operator instructions of changing values of the items when the display controller makes the display portion display the operation guide screen, and
the display controller allows a display form of a display part for a predetermined description be different from other display area in the operation guide screen when the display controller allows the display portion to display the operation guide screen on the display portion.

30. The display device according to claim 29, wherein the display controller allows the display portion to display one or more items and its or their set values in display frames being separate from the operation guide screen and serving as the display part for the predetermined description when the display controller allows the display portion to display the operation guide screen.

31. The display device according to claim 29, wherein:
the display controller allows the display portion to display a default screen which serves as an operation guide screen enabling an operator to change set values of one or more items, and a second screen which is operable to change the set value of one or more items and displayed when switched from the default screen,
the set change reception portion receives from the operator an instruction of changing the set value of the item when the display controller allows the display portion to display the default screen or the second screen, and
the display controller further allows the display portion to display in the default screen the set value of the item which is changeable in the second screen as the display part of the predetermined description.

32. The display device according to claim 29, wherein:
the display controller allows the display portion to display a default screen which serves as an operation guide screen enabling the operator to change the set value of one or more items, and the second screen which is operable to change a set value of one or more items and displayed when switched from the default screen,
the set change reception portion receives from the operator an instruction of changing a set value of an item when the display controller allows the display portion to display the default screen or the second screen, and
the display controller further allows the display portion to display a display part of a set value changed in the second screen transmissively in the default screen when a set value of at least one of the items changeable in the second screen is changed in accordance with a set change instruction received in the set change reception portion.

33. A display control method for allowing a display portion to display an operation guide for an operator, comprising the steps of:
(1) allowing the display portion to display an operation guide screen presenting to an operator that values of a plurality of items are changeable; and
(2) allowing the display portion to display a display part for a predetermined description to be in a display form which is different from other display area in the operation guide screen when a predetermined requirement is met.

34. The display control method according to claim 33, wherein, in step (2), the display portion is allowed to display the plurality of items and their set values in display frames being separate from the operation guide screen when the predetermined requirement is met.

35. The display control method according to claim 33, wherein:
in step (1), the display portion displays a default screen which serves as an operation guide screen enabling an operator to change set values of one or more items, and a second screen which is operable to change the set value of one or more items and displayed when switched from the default screen are displayed, and
in step (2), the display portion displays the set value of the item which is changeable in the default screen when the display portion displays the default screen or the second screen in step (1) and receives from the operator an instruction of changing the set value of the item.

36. The display control method according to claim 33, wherein:
in step (1), the display portion displays a default screen which serves as an operation guide screen enabling an operator to change set values of one or more items, and a second screen which is operable to change the set value of one or more items and displayed when switched from the default screen are displayed, and
in step (2), the display portion receives from the operator an instruction of changing a set value of an item when the display portion displays in step (1) the default screen or the second screen; and the display portion displays a display part of a set value changed in the second screen transmissively in the default screen when a set value of at least one of the items changeable in the second screen is changed in accordance with a set change instruction received in the set change reception portion.

37. An image forming apparatus, comprising:
an image forming portion which performs a sequence of image forming operation to a recording sheet;
a display portion which displays an operation guide regarding the image forming operation;
a display controller which allows the display portion to display an operation guide screen presenting to an operator that values of a plurality of items are changeable;
a set change reception portion which receives from the operator instructions of changing values of the items when the display controller allows the display portion to display the operation guide frame, wherein
the display controller allows a display form of a display part for a predetermined description to be different from other display area in the operation guide screen when the display controller allows the display portion to display the operation guide screen.

38. The image forming apparatus according to claim 37, wherein:
the display controller allows the display portion to display one or more items and its or their set values in a display frame which is separate from the operation guide screen when the display controller allows the display portion to display the operation guide screen.

39. The image forming apparatus according to claim 37, wherein:
the display controller allows the display portion to display a default screen which serves as an operation guide screen enabling an operator to change set values of one or more items, and a second screen which is operable to change the set value of one or more items and displayed when switched from the default screen,
the set change reception portion receives from the operator an instruction of changing the set value of the item when the display controller allows the display portion to display the default screen or the second screen, and
the display controller further allows the display portion to display in the default screen the set value of the item which is changeable in the second screen as the display part of the predetermined description.

40. The image forming apparatus according to claim 37, wherein:
the display controller allows the display portion to display a default screen which serves as an operation guide screen enabling the operator to change the set value of one or more items, and the second screen which is operable to change a set value of one or more items and displayed when switched from the default screen,
the set change reception portion receives from the operator an instruction of changing a set value of an item when the display controller allows the display portion to display the default screen or the second screen, and
the display controller further allows the display portion to display a display part of a set value changed in the second screen transmissively in the default screen when a set value of at least one of the items changeable in the second screen is changed in accordance with a set change instruction received in the set change reception portion.
